(19) United States
(12) Patent Application Publication
(10) Pub. No.: US 2006/0056573 A1
(43) Pub. Date: Mar. 16, 2006

(54) Micro neutron detectors

(76) Inventors: Douglas S. McGregor, Riley, KS (US); Martin F. Ohmes, Manhattan, KS (US); John K. Shultis, Manhattan, KS (US)

Correspondence Address: KING & SCHICKLI, PLLC, 247 NORTH BROADWAY, LEXINGTON, KY, 40507, US

(21) Appl. No.: 11/191,326

(22) Filed: Jul. 28, 2005

Related U.S. Application Data
(60) Provisional application No. 60/592,314, filed on Jul. 29, 2004.

(51) Int. Cl. G21C 3/32

(52) U.S. Cl. 376/434

(57) ABSTRACT

Micro neutron detectors include relatively small pockets of gas including a neutron reactive material. During use, under a voltage bias in a neutron environment, neutron interactions in the neutron reactive material are seen to occur. Ultimately, electron-ion pairs form and positive ions drift to a cathode and electrons to the anode. The motion of charges then produces an induced current that is sensed and measurable, thereby indicating the presence of neutrons. Preferred pocket volumes range from a few cubic microns to about 1200 mm³; neutron reactive materials include fissionable, fertile or fissile material (or combinations), such as ²³⁵U, ²³⁸U, ²³³U, ²³²Th, ²³⁹Pu, ¹⁰B, ⁶Li and ⁶LiF; gasses include one or more of argon, P-10, ³He, BF₃, BF₃, CO₂, Xe, C₄H₁₀, CH₄, C₂H₆, CF₄, C₃H₈, dimethyl ether, C₃H₆ and C₃H₈. Arrangements include two- and three-piece sections, arrays (including or not triads capable of performing multiple detecting functions) and/or capillary channels.

This application claims priority to and the benefit of U.S. Provisional Application No. 60/592,314, filed Jul. 29, 2004.

### STATEMENT OF GOVERNMENT RIGHTS

The invention was partially funded by the U.S. Government, under the Department of Energy, Nuclear Energy Research Initiative (NERI) Grant Number DE-FG03-02SF22611. Accordingly, the U.S. Government may reserve certain rights to its use.

### FIELD OF THE INVENTION

This invention relates generally to radiation detectors. In particular, the invention relates to semiconductor detectors designed to detect neutrons of various energy ranges. More particularly, the invention relates to micro neutron detectors useful for the real-time monitoring of both near-core and in-core neutron fluxes of nuclear reactors.

### BACKGROUND OF THE INVENTION

Nuclear reactors convert mass into energy. Although nuclear fusion provides an alternative means of energy production, limitations in scientific understanding currently limit energy production to those reactors utilizing nuclear fission. Nuclear fission occurs when an atom breaks apart, either spontaneously or due to some disruptive force. The total mass of the resulting products, usually two smaller atoms or nuclei and one or more neutrons, is less than the mass of the initial atom. The energy emitted by the reaction directly correlates to the difference in mass between the two objects according to the relationship E=m*c². Importantly, within a nuclear reactor, the neutrons emitted as a result of the reaction radiate until they come in contact with another object. When this object is an atom susceptible to fission, the collision provides the disruptive force necessary to instate division of the atom. The second division emits additional neutrons, as does each additional division, resulting in a chain reaction. Thus, the energy generated in a given location relates directly to the corresponding neutron flux.

Presently, the state of the art of neutron detectors for reactors contemplates a variety of materials and sizes. For instance, small semiconductor detectors, such as Si, bulk GaAs and diamond detectors, subsequently coated with neutron reactive materials have been investigated. While they achieve advantage with their small size and compactness, they generally catastrophically fail for neutron fluences that are much too low for in-core/near-core routine neutron measurements, except perhaps for a few, such as SiC or amorphous Si. Gas-filled chambers, on the other hand, with ²³⁵U added as a film coating or as an internal foil, for example, are used to measure high neutron fluxes near a reactor core. Advantageously, these devices are radiation hard and are insensitive to gamma ray background. Disadvantageously, they generally require relatively high voltages and are quite large. Appreciating some of the smaller still have chamber sizes on the order of 1200 mm³ or more, this makes response times relatively very slow, hence adding to detector dead time. Further, the devices are too large to be used as single point detectors for back-projection calculations. Still other devices, known as “self-powered” detectors, are generally manufactured from rhodium or vanadium and used for in-core reactor measurements. While these devices can be inserted in tiny areas and are relatively insensitive to gamma ray background, they cannot provide an immediate response to a change in a reactor's neutron flux. Instead, rhodium and vanadium detectors, which rely on the radioactive decay of a neutron activated material, provide only an average value and can take up to 5 minutes to reach equilibrium.

Accordingly, there is a need for small compact neutron detection devices that can be used for in-core, real-time neutron flux measurements of both power and naval nuclear reactors. Simultaneously, however, the devices must be small enough so as to easily fit within the constraints of the reactor core physical design and have adequate sensitivity to the neutron flux while not perturbing the neutrons so as to alter reactor operations. In other words, the devices cannot be so large that they absorb too many neutrons and thereby affect the neutron chain reaction of the reactor.

### SUMMARY OF THE INVENTION

The above-mentioned and other problems become solved by applying the principles and teachings associated with the hereinafter described micro neutron detectors.

In one aspect, the micro neutron detectors have relatively small size and include pockets, for containing a gas, having a volume on the order from a few cubic microns to 1200 mm³. A neutron reactive material, such as a fissionable, fertile or fissile material or combinations thereof, like ²³⁵U, ²³⁸U, ²³³U, ²³²Th, ²³⁹Pu, ¹⁰B, ⁶Li or ⁶LiF, is in contact with the gas and an electrical bias is placed across the pocket. In this manner, neutron interactions in the reactive coating cause charged particles to eject in opposite directions. When these energetic ionizing particles enter the gas pocket, they produce ionization in the form of electron-ion pairs. In turn, the applied voltage causes the positive ions and the electrons to separate and drift apart, electrons to the anode and positive ions to the cathode. The motion of the charges then produces an induced current that is sensed and measurable, thereby indicating the presence of neutrons. Preferably, the result embodies a measurable pulse indicating the presence of a neutron having been interacted in the detector.

In another aspect, the detectors are physically arranged as two clamshelled sections, three sandwiched supports, an array of a multiplicity of detectors, a triad of detectors each capable of performing a different detecting function and/or a variety of capillary channels formed in substrates. Specific clamshelled section embodiments include two insulator halves with openings joined together to form a pocket. On a surface of one or both of the insulator halves, a coating of a neutron reactive material is applied. A conductive coating contacting the neutron reactive material is further applied and fashioned with electrical leads to ultimately apply a bias across the pocket and neutron reactive coating during use. Specific sandwiched support embodiments include three supports with an interior support having openings that form a gas pocket. Coatings of the neutron reactive material and conductors are applied on the exterior supports in the vicinity of the openings and, when fastened/sandwiched, create a gas pocket capable of having an electrical bias applied across. Specific triads of detectors embody the foregoing three supports with three openings in the interior support. In the vicinity of two of the three openings, neutron reactive materials and conductor materials are applied on the exterior supports. However, one of the openings clearly lacks such coatings. Also, the coatings of neutron reactive materials differ from one another so that each detector can serve a different detecting role. Namely, fast or thermal neutron detection. The opening without a neutron reactive coating, in turn, serves as a background or baseline reading detector. Specific embodiments of capillary channels contemplate multiple substrates etched to create a plurality of peaks and valleys so that upon joining, the substrates matingly define pluralities of pockets for receiving/containing gas. The unique capillary channel design allows for signals to be extracted from individual detectors along each channel. Further, unlike multi-wire gas detectors, the walls separating the channels prevent excited charges from entering the detector space of an adjacent channel, hence preventing electronics signals being shared between two or more detectors, an effect often termed as “crosstalk.” Also, a neutron reactive material is applied to one or both of the substrates as well as various conductive coatings for facilitating the electrical bias across the pocket. Certainly, thin film and VLSI techniques are contemplated in this regard. Regardless of type, preferred gases in the detectors variously include argon, P-10, ³He, BF₃ and mixtures of argon, He, BF₃, CO₂, Xe, C₄H₁₀, CH₄, C₂H₆, CF₄, C₃H₈, dimethyl ether, C₃H₆ and C₃H₈.

Methods of making the detectors broadly include providing a gas environment, assembling a neutron reactive material to form at least a portion of a pocket therein and sealing the pocket. Then, upon removal of the pocket from the gas environment, the pocket retains the gas of the gas environment. Further manufacturing techniques include coatings of uranyl and thorium nitrate applied via thin film deposition, vapor depositions such as evaporation with electron-beam techniques, sputtering, or the like.

In still alternate embodiments of the invention, one or more detectors are provided directly with one or more fuel bundles for use in a reactor. In this manner, upon inserting the fuel into the reactor, detectors are also inserted and provide an instantaneous in-core neutron flux measurement capability. During use, this also adds to reactor fuel efficiency increases because real-time adjustments of fuel bundle location or locating spotty fuel burn-up, for example, can be made based on the output readings of the detectors. Appreciating average fuel bundles cost hundreds of thousands of dollars or more, the more effective burning of fuel will certainly save money too. Further, upon removal of the fuel bundle from the reactor, after use, the detectors can remain with the bundle and later provide an indication of the state of the bundles, such as before/during transportation to waste sites. Operating nuclear reactors with detectors disposed in their moderator are also contemplated with and apart from the detectors with the fuel bundle embodiment. Flux mapping of the core also results with these detectors regardless of use with the fuel bundle. In turn, mapping results in learning core efficiencies, for instance.

With more specificity, it is expected that many detectors will be placed at various positions throughout the core of the nuclear reactor and it will become possible to generate a three-dimensional (3-D) map of the neutron flux within the core. In one instance, several detectors will be placed on a rod, for example. Each rod will then be placed at a position within the reactor core. By monitoring the readings from each detector, the position of which is known, plotting programs can generate a 3-D map of the real-time neutron flux throughout the core. Since some detectors may embody a triad serving the simultaneous role of detecting fast and thermal neutrons, and distinguishing same from the background, the 3-D map will also have the capability of superimposition in that a 3-D map of thermal neutron flux, can be superimposed upon a 3-D map of fast neutron flux, which in turn can be superimposed upon a 3-D map of the gamma ray flux. Heretofore, this was unknown. Also, this map will be useful for showing any unevenness within the core, any spurious problems, or any additional problems associated with neutron/gamma ray fluxes.

In a broad sense, the many embodiments of micro neutron detectors of the invention overcome the problems of the prior art and provide neutron radiation detection in a manner, heretofore unknown, capable of simultaneously withstanding intense radiation fields, capable of performing “near-core” and “in-core” reactor measurements, capable of pulse mode or current mode operation, capable of discriminating neutron signals from background gamma ray signals, and tiny enough to be inserted directly into a nuclear reactor without significantly perturbing the neutron flux. Advantageously, the invention accomplishes this with a new type of compact radiation detector based on the fission chamber concept and is useful for at least three specific purposes: (1) as reactor power level monitors, (2) power transient monitors, and (3) real-time monitoring of neutron flux profiles of a reactor core. The third application also has the unique benefit of providing information that, with inversion techniques, can be used to infer the three-dimensional distribution of fission neutron production in the core. Additional uses of the disclosed invention may include the detection of nuclear weapons, weapons-grade plutonium, or both.

It is important to reiterate that the micro neutron detectors proposed herein are unique because of their miniature size and rapid response time. Some of the important features, but by no means limiting, include:

1. Compact size—the dimensions of the micro neutron detectors are small, similar to semiconductor devices, and easy to operate in tight environments. Compactness also enables simultaneous use of pluralities of detectors thereby building in neutron detection redundancy.

2. Thermally resistant—the micro neutron detectors can be manufactured from high-temperature ceramics or high temperature radiation resistant materials that can withstand the high-temperatures and harsh environment of a nuclear reactor core.

3. Gamma ray insensitive—the detection gas, small size, and light material composition all work to make the device gamma ray insensitive, hence the neutron signals output from the micro neutron detectors will be easily discernable from background gamma ray interference. As a result, the detectors naturally discriminate out gamma ray background noise from neutron interactions.

4. Inexpensive—construction is straightforward and requires inexpensive materials, such as aluminum oxide or oxidized silicon; construction also takes advantage of well known techniques such as thin film deposition and VLSI processing techniques.

5. Large signals—the reaction products are highly energetic and the output signals of the micro neutron detectors are easy to detect.

6. Radiation hardness—the structure of the detectors is radiation hard because the electronic material is a gas, not a solid, hence it does not undergo structural damage. The detectors survive neutron fluences 1,000 times greater than that which prior art semiconductor devices are capable of.

7. Low power requirement—the detectors preferably operate with applied biases as low as 20 volts; ranges include about 1 to about 1000 volts.

8. Tailored efficiency—the detectors can be constructed to have low (<0.001%) efficiency up to 7% efficiency such that it can be used for several different applications.

9. Deployment at Power Reactors—Successful demonstration of the detectors is leading to detector usage in the nuclear industry, including naval and commercial nuclear reactors with practical applications contemplating: 1) nuclear reactor core instrumentation for the present power industry; 2) nuclear reactor core instrumentation for naval reactor vessels; 3) imaging arrays for neutron imaging at neutron radiography ports; 4) imaging arrays for neutron sensing at neutron scattering centers such as the DOE Spallation Neuron Source; 5) nuclear fuel burn-up monitors in power reactors; 6) localized point flux monitors for reactors and beam ports; and 7) regulation of nuclear weapons.

In the regulation of nuclear weapons, neutron detection requirements for support of arms control agreements pose challenges that conventional detector designs cannot meet. For example, detector designs must be able to determine the number of Reentry Vehicles (RV) in an assembled missile without removing the aerodynamic shield or collecting critical nuclear weapons design information (CNWDI). Further, the technology must meet the approval of all treaty partners. One treaty partner, Russia, is particularly sensitive about new high technology detectors, fearing that they could be subverted for intelligence gathering applications. Currently, a neutron detector designed by Sandia National Laboratory is used for treaty confidence building tests, however it does not have direction sensing capability, and cannot be used for this field application. Nonetheless, since all parties have found a neutron detector acceptable, one can reasonably assume that a directional sensitive neutron detector would also be acceptable.

Incorporating the teachings of the instant invention, a radiation-hardened neutron-imaging device can be produced. The new devices can have directional dependence that can be used to assess the origin of the neutrons. The neutron radiation imaging detectors are gamma ray insensitive, have high spatial resolution, have relatively high neutron detection efficiency, are compact in thickness, radiation hard, and are capable of imaging large areas.

In this regard, the inventors introduce a new array type of gas detector that will operate well as an inexpensive, easily maintainable, neutron detector for both thermal and fast neutron fields. The expected high sensitivity of the detector and flat plate design may make it useful for detecting the presence of highly enriched uranium (HEU) and weapons grade plutonium (WGPu) in packages as well as imaging support for neutron physics experiments at national laboratory facilities. With such configuration, the sensitivity should be sufficient to identify WGPu in reasonably sized packages with or without active interrogation of the package with a neutron source. Because the count rate is expected to be low, and also because the design keeps the volume of the detection gas low, it should be possible to charge the detector with gas and use it without a gas recharge for as long as 24 hours. Other variations can use continuous gas flow as the source. The new detector will also permit high-resolution digital neutron radiography on objects where photon radiography is impossible, and will permit further advances in nuclear physics and engineering by the availability of inexpensive neutron detectors that can be optimized to their requirements.

Additional benefits of the current invention in the foregoing regard, especially embodiments having pockets as capillary channels, include but are not limited to:

1. Directionally Dependent—Neutrons incident on the front face of the detector will be detected while the thickness of the detector, generally, makes interactions from the sides unlikely.

2. High-spatial resolution—the spatial resolution is determined by the strip pitch.

3. Gamma ray insensitive—gas-filled or gas-flow detectors are typically insensitive to gamma rays. The large signals produced by the fission fragments will be easily discriminated from any gamma ray events.

4. No cross talk—pockets as capillary channels have walls substantially preventing charges from entering adjacent regions.

5. Compact—the detectors will be only a few millimeters thick.

6. Large area—substrates can be 8 or more inches in diameter.

7. Stackable for efficiency—the compactness enables stacking of detectors to increase efficiency, if needed.

8. Neutron Energy—By placing different thickness of moderator over different sections of the detector, a rough estimate of the incident neutron energy can be made.

### BRIEF DESCRIPTION OF THE DRAWINGS

FIG. 1 is a diagrammatic view in accordance with the present invention of a representative micro neutron detector formed, for example, as two halves;

FIG. 2 is a diagrammatic view in accordance with the present invention of an assembled and operational micro neutron detector of FIG. 1;

FIG. 3 is a diagrammatic view in accordance with the present invention of an alternate representative of a micro neutron detector formed, for example, with three supports;

FIG. 4 is a diagrammatic view in accordance with the present invention of an assembled and operational micro neutron detector of FIG. 3;

FIG. 5 is a diagrammatic, cut away view in accordance with the present invention of an assembled micro neutron detector according to FIGS. 3 and 4;

FIGS. 6a and 6b are diagrammatic views in accordance with the present invention of representative array of a plurality of micro neutron detectors;

FIGS. 7a and 7b are diagrammatic views in accordance with the present invention of the array of FIGS. 6a and 6b including a protective sleeve for insertion, perhaps, into a neutron environment;

FIG. 8 is a diagrammatic view in accordance with the present invention of an alternate representative array of a plurality of micro neutron detectors fashioned as a triad;

FIGS. 9-12 are diagrammatic views in accordance with the present invention of a variety of supports for use in making a micro neutron detector;

FIG. 13 is a diagrammatic view in accordance with the present invention of an assembled array of micro neutron detectors including additional functionality;

FIG. 14 is a graph in accordance with the present invention of energy deposition and ranges for ¹⁰B reaction products in 1 atm of P-10 gas;

FIG. 15 is a graph in accordance with the present invention of energy deposition and ranges for ¹⁰B reaction products in a micro neutron detector;

FIG. 16 is a graph in accordance with the present invention of a thermal neutron reaction product spectrum taken with a prototype ¹⁰B-coated micro neutron detector as a representative micro neutron detector;

FIG. 17 is a graph in accordance with the present invention of energy deposition and ranges for typical fission fragments in 1 atm of P-10 gas;

FIG. 18 is a graph in accordance with the present invention of energy deposition and ranges for typical fission fragments in a representative micro neutron detector;

FIG. 19a is a graph in accordance with the present invention of a thermal neutron induced spectrum from a prototype micro neutron detector;

FIG. 19b is a graph in accordance with the present invention of a predicted thermal neutron induced spectrum, generated using a Monte Carlo code based on various micro neutron detector dimensions;

FIG. 20a is a graph in accordance with the present invention of a prototype micro neutron detector count rate as a function of reactor power;

FIG. 20b is a diagrammatic view in accordance with the present invention of a side-view diagram of the Kansas State University TRIGA Mark II nuclear reactor facility in which data of the instant invention has been gathered;

FIG. 20c is a top-view photograph in accordance with the present invention of the reactor facility of FIG. 20b, including showing the core and graphite moderator;

FIG. 20d is a diagrammatic view in accordance with the present invention of the reactor facility of FIG. 20b showing the reactor core arrangement, including fuel and grid plate openings and positions for inserting/placing micro neutron detectors in-core;

FIG. 21 is a diagrammatic view in accordance with the present invention of an alternate embodiment of a micro neutron detector;

FIG. 22 is a diagrammatic view in accordance with the present invention of an assembled micro neutron detector of FIG. 21, including an enlarged view of representative neutrons interacting in a neutron reactive material;

FIG. 23 is a diagrammatic, perspective view in accordance with the present invention of a portion of the micro neutron detector of FIGS. 21 and 22;

FIGS. 24a and 24b are diagrammatic views in accordance with the present invention of two possible methodologies for patterning the micro neutron detectors of FIGS. 21-23 such that gas can continuously flow through the detectors;

FIG. 25 is a diagrammatic, perspective view in accordance with the present invention of an assembled embodiment of a micro neutron detector showing gas flow;

FIG. 26 is a diagrammatic view in accordance with the present invention of an alternate method to assemble a micro neutron detector;

FIG. 27 is a diagrammatic view in accordance with the present invention of still another alternate method to assemble a micro neutron detector;

FIG. 28 is a diagrammatic view in accordance with the present invention of yet another alternate method to assemble a micro neutron detector;

FIG. 29 is a diagrammatic view in accordance with the present invention of an assembled micro neutron detector mounted for use on a printed circuit board interconnected to external electronics and gas supplies;

FIG. 30 is a diagrammatic view in accordance with the present invention of yet another embodiment for making a micro neutron detector;

FIG. 31 is a graph in accordance with the present invention of a lifetime optimization of a neutron reactive material as a coating in a micro neutron detector;

FIG. 32 is a graph in accordance with the present invention of gamma energy deposition in 500 μm of 1 atm of argon gas;

FIG. 33 is a diagrammatic view in accordance with the present invention of a fuel bundle having a micro neutron detector and a nuclear reactor including same;

FIG. 34 is a diagrammatic view in accordance with the present invention of an alternate fuel bundle having a micro neutron detector and a nuclear reactor including same; and

FIG. 35 is a diagrammatic view in accordance with the present invention of a three-dimensional neutron flux map for a nuclear reactor constructed from a plurality of micro neutron detectors.

### DETAILED DESCRIPTION OF THE PREFERRED EMBODIMENTS

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized without departing from the scope of the invention. The following, therefore, is not to be taken in a limiting sense, and the scope of the present invention is defined only by the appended claims and their equivalents. In accordance with the present invention, varieties of micro neutron detectors and their methods of making and using are hereafter described.

As a preliminary matter, the inventors investigated a variety of neutron reactive materials and their properties for use in making and using micro neutron detectors. As skilled artisans appreciate, only neutrons within certain energy levels will result in detection for a given detector. For example, thermal neutrons (0.0259 eV) absorbed by ¹⁰B produce energetic charged particles, emitted at a 180° angle, with a 94% probability of producing a 1.47 MeV α-particle and an 840 keV ⁷Li ion, and a 6% probability of producing a 1.78 MeV α-particle and a 1.0 MeV ⁷Li ion. The 2200-m/s neutron microscopic absorption cross-section is 3840 barns, and the microscopic absorption cross-section (σ) follows an inverse velocity dependence over much of the thermal energy range. The macroscopic thermal neutron absorption cross-section for pure ¹⁰B is 500 cm⁻¹. Hence, ¹⁰B has excellent properties for use in detecting neutrons, especially if arranged thinly as a film. Other examples especially investigated included ⁶LiF, pure ⁶Li, ²³²Th, and ²³⁵U. For these, thermal neutron reactions in ⁶Li-based films yield 2.05 MeV alpha particles and 2.73 MeV tritons. Pure ⁶Li, on the other hand, is highly reactive and decomposes easily; however, pure ⁶LiF is adequately stable and has microscopic and macroscopic thermal neutron cross-sections of 940 barns and 57.5 cm⁻¹, respectively. Of greatest interest, however, is the ²³⁵U fission reaction as a conversion material. As is known, pure ²³⁵U has microscopic and macroscopic thermal neutron fission cross-sections of 577 barns and 28 cm⁻¹, respectively. Fission reactions in ²³⁵U also cause the emission of two fission fragments per fission with energies ranging from 60 MeV to 100 MeV, energies easily discernable from background gamma rays.

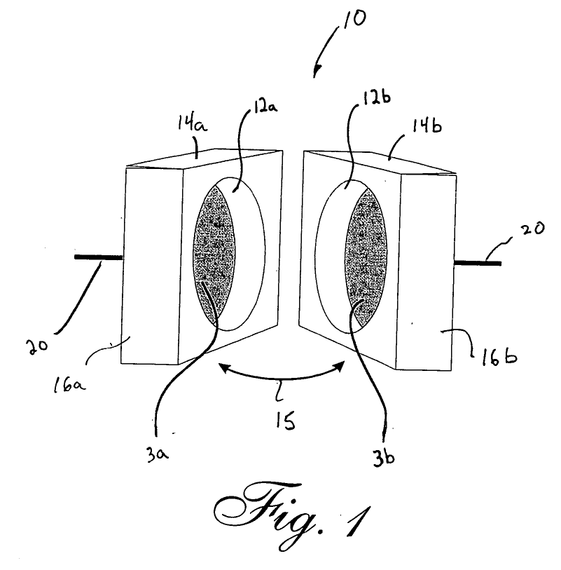

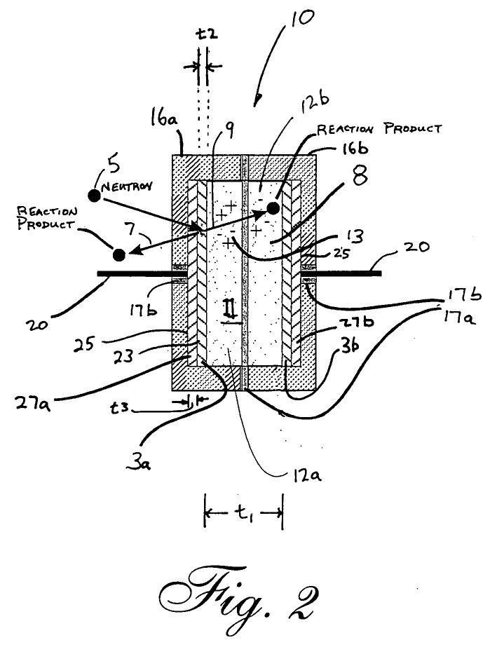

With reference to FIGS. 1 and 2, a first embodiment of a micro neutron detector according to the invention is given generically as element 10. Broadly stated, the detector includes: a pocket, with gas; a neutron reactive material; and means for electrically biasing the pocket and neutron reactive material. In this manner, when introduced in a neutron environment (given generically as neutron 5), neutron interactions in the neutron reactive material 3 cause charged particles (reaction product) to eject in opposite directions 7, 9. When these energetic ionizing particles enter the pocket 11 filled with gas 8, they produce ionization in the form of electron-ion pairs 13. In turn, the applied voltage causes the positive ions and the electrons to separate and drift apart, electrons (−) to the anode and positive ions (+) to the cathode. The motion of the charges then produces an induced current that is sensed and measurable (e.g., signal), thereby indicating the interaction of neutron(s) in the detector. Electrical leads 20 provide the means to apply voltage to the detector and also extract the electronic signal from the detector.

With more specificity, FIG. 1 shows an unassembled detector 10 in two halves 14a, 14b that are brought together in the direction of bi-directional arrow 15, e.g., clamshelled, to form a pocket 11 in FIG. 2. The pocket 11 is defined by openings 12a, 12b in a housing 16a, 16b that embody the two halves. In a preferred instance of manufacturing, the housing is void of neutron-reactive or neutron-absorbing material and includes insulators, such as ceramics, aluminum oxide or oxidized silicon, and the openings 12a, 12b are formed by cutting or etching a hole therein. Resulting volume size of the pocket preferably includes anything on the order of less than about 1200 mm³. More preferably, the volume ranges from a few cubic micrometers to about less than 10 mm³ with a presently implemented design being about 0.39 mm³. With this in mind, a pocket having a cylindrical shape, as shown, has a preferred radius in each of the openings 12a, 12b of less than about 2 mm while a thickness t1 of the pocket 11 is less than about 2 mm. Of course, any sizes are possible as are any shapes of the pocket. Examples of this will be seen and described relative to other figures.

Forming a portion of the pocket, and constructed to be in contact with the gas 8 during use, is a neutron reactive material 3. In a preferred embodiment, the neutron reactive material is a layer of about one micrometer thick, t2, and embodies either a fissionable, fertile or a fissile material. In this regard, representative compositions include ²³⁵U, ²³⁸U, ²³³U, ²³²Th, ²³⁹Pu, ²⁴¹Pu, ¹⁰B, ⁶Li and ⁶LiF, for example. In other embodiments, the neutron reactive material typifies a combination of the fissionable, fertile and fissile materials. In general, however, the line between fissionable, fertile and fissile materials is drawn, according to the invention, as: fissionable materials are materials that fission upon the absorption of a neutron with energy greater than the fission critical energy which consist of, but are not limited to, ²³⁸U and ²³²Th; fertile materials are materials that become either fissile or fissionable materials upon the absorption of a neutron which consist of, but are not limited to, ²³⁸U; and fissile materials are materials that fission upon the absorption of a zero energy neutron and consist of, but are not limited to, ²³⁵U; ²³³U; ²³⁹Pu; and ²⁴¹Pu. Naturally, skilled artisans can contemplate other materials. Further, control of the composition of the neutron reactive material and its thickness, leads to tailoring of detector type and neutron detection efficiency. In general, thin neutron reactive coatings lead to decreased neutron interaction rates while thicker neutron reactive coatings lead to increased rates.

Methods of applying the neutron reactive material vary. In the past, the layer was deposited through a process in which uranyl-nitrate was coated onto the conductive layer and then allowed to dry. The currently preferred method of application involves electroplating the detector within an electrochemical bath. In one instance, a solution of uranyl-nitrate or thorium nitrate covers that area of the detector needing coating. The detector then connects to a negative terminal of an external voltage supply (not shown). As a result, the positively charged uranium based ions attract to the negatively charged device, forming a thin layer of the neutron reactive material. However, other contemplated methods of applying the reactive material include well known thin film or other deposition techniques, such as chemical vapor deposition, physical vapor deposition (e.g., evaporation), sputtering, direct coating (such as painting with a brush or allowing a drop of diluted solution to dry on a surface). Further, the geometric shapes of the contacts and neutron reactive materials may be defined with deep or regular reactive ion etching, photolithography, electron-beam evaporation and lift-off techniques or the like.

Regardless of formation, skilled artisans will observe that the neutron reactive material in the figures embodies two layers or sections 3a and 3b on either sides of the pocket. However, the invention alternatively embraces only a single instance of the neutron reactive material on a single side of the pocket and may exist as either 3a on the left or 3b on the right. Still further, other embodiments appreciate the shape of the pocket will vary as regular or irregular shapes/surfaces and the neutron reactive material need only be applied with sufficient volume and position to cause the aforementioned interaction of neutrons to occur upon the application of an electrical bias.

On a surface 23 of the neutron reactive material, and on a surface 25 of the housing 16a, 16b, for example, a conductive material 27a, 27b, resides having a thickness t3 of about one micrometer. In one aspect, the conductive material includes any conductor including, but not limited to, copper, gold, silver, aluminum, titanium, nickel, zinc, platinum, palladium, etc. In other aspects, the conductor is a composition of conductors and/or other materials. In a preferred embodiment, the material is a mixture of Ti/Au having respective concentration amounts of about 10% and 90%, or Ti/Pt having respective concentration amounts of about 10% and 90%. Similar to the neutron reactive material, the conductive material can be applied via a variety of mechanisms and include those previously mentioned.

Connected to the conductive material through a hole in the housing are electrical leads 20. In this manner, the aforementioned electrical bias of the pocket and neutron reactive material can be applied. In a preferred embodiment, the electrical leads include pure or combinations of conductors as mentioned relative to the conductive material. In thickness, the cross-section of the leads varies and is sufficient to apply a voltage bias to the neutron reactive material and pocket in a range from about 1 volt to about 1000 volts. Naturally, a sealant 17b fills the hole in the housing to seal the pocket 11 from gas leaks and secure the electrical leads in place. Optionally, this same sealant or another 17a also exists between the two halves of the housing to adhere the halves together and seal the pocket shut from ambient conditions. Although not preferred, mechanical fasteners could further be used in this regard. In either, the structures need to be able to withstand relatively high temperatures as they will be exposed to the hostile environment of a nuclear reactor.

The gas 8 of the pocket 11 preferably includes one of argon, P-10, ³He, BF₃, and mixtures of Ar, He, BF₃, CO₂, Xe, C₄H₁₀, CH₄, C₂H₆, CF₄, C₃H₈, dimethyl ether, C₃H₆ or C₃H₈. It may be pressurized too if desired. Pressurizing, or not, like increasing or decreasing neutron reactive material thicknesses, leads to tailoring of neutron detection efficiency. In general, low pressure gas leads to smaller signals, while higher pressure gas leads to larger signals, with a typical range of possible gas pressures ranging from about 0.1 atm to about 10 atm. Introduction of the gas to the pocket may occur in a variety of ways. In one instance, gas fills the pocket simply by constructing the detector and sealing it in a gas environment, such as under a gas hood (not shown). In another, gas is supplied via external sources and will be described below. In still another, gas may represent the ambient air and exists in the pocket simply by constructing the detector in other than a vacuum setting.

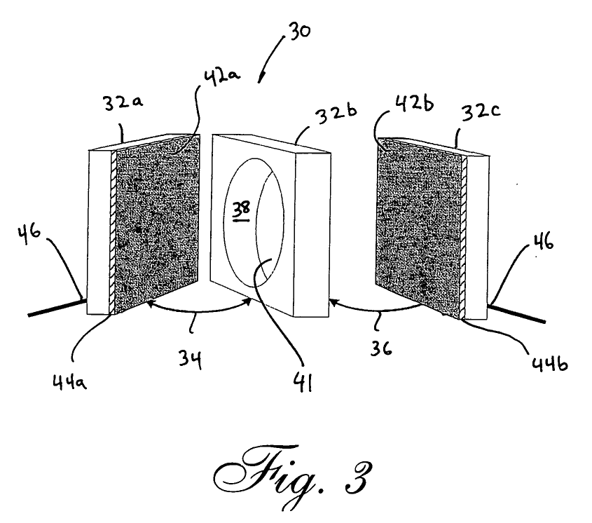

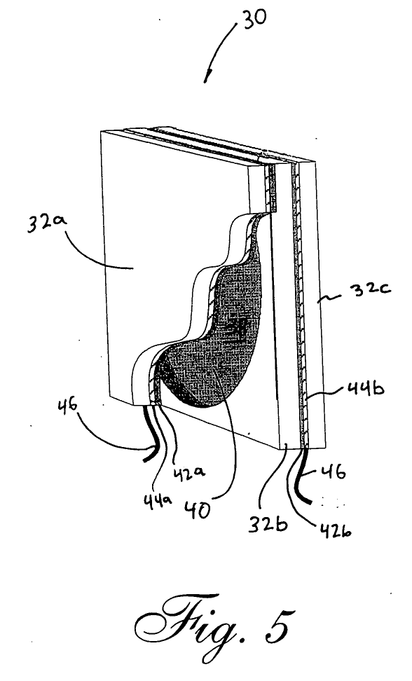

With reference to FIGS. 3-5, another embodiment of the invention includes a micro neutron detector given generically as 30. In this design, a plurality of substrates or insulator supports 32a, 32b, 32c are fastened together in the direction of arrows 34, 36, e.g., sandwiched, to form a pocket 38 filled with gas 40. In one aspect, an opening 41 or hole is milled, etched or otherwise cut into an interior support 32b and when closed or sandwiched by exterior supports 32a, 32c, the pocket is fully defined. The supports themselves may embody any material so long as they are non neutron absorbing or reacting. Preferred supports include alumina but could also embody a glassified semiconductor substrate, such as oxidized silicon. As before, resulting pocket volumes of the invention range from a few cubic micrometers to less than about 1200 mm³ and are of any shape. A neutron reactive material exists in contact with the gas and forms a portion of the pocket on either or both sides at positions 42a, 42b. Contacting the neutron reactive material and the exterior supports, is a conductive material 44a, 44b for obtaining detector signals and applying an electrical bias across the pocket and neutron reactive material via the functionality of electrical leads 46. A sealant 48 is also used in this design to seal the pocket from gas leaks, connect the supports 32 together and support the leads. Naturally, the leads could also contact the conductive material in the same fashion as previously described (e.g., through a hole in an exterior support). Construction of this device could also occur in a gas environment as previously described to fill the pocket 38.

Also, the in use application of neutron detection occurs as previously described in a neutron environment 5, with reaction products occurring in directions 7, 9 upon neutron contact with the neutron reactive material 42. In turn, when these energetic ionizing particles enter the pocket 38 filled with gas 40, they produce ionization in the form of electron-ion pairs 13. The applied voltage then causes the positive ions and the electrons to separate and drift apart, electrons (−) to the anode and positive ions (+) to the cathode. The motion of the charges then produces an induced current that is sensed and measurable (e.g., signal), thereby indicating the interaction of neutron(s) in the detector.

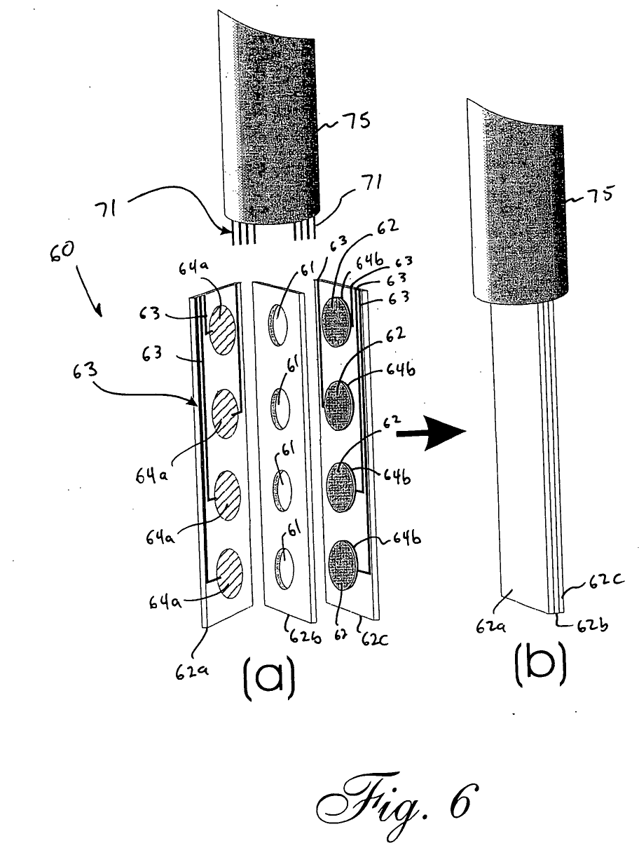

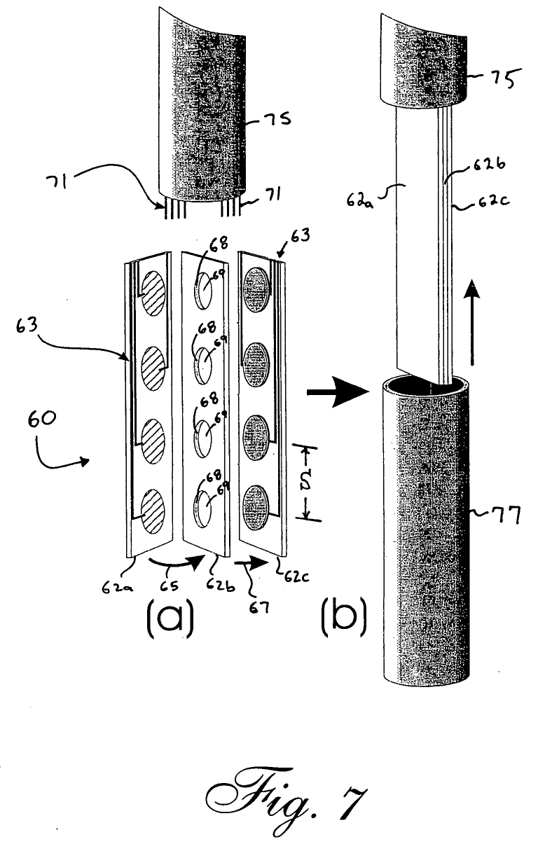

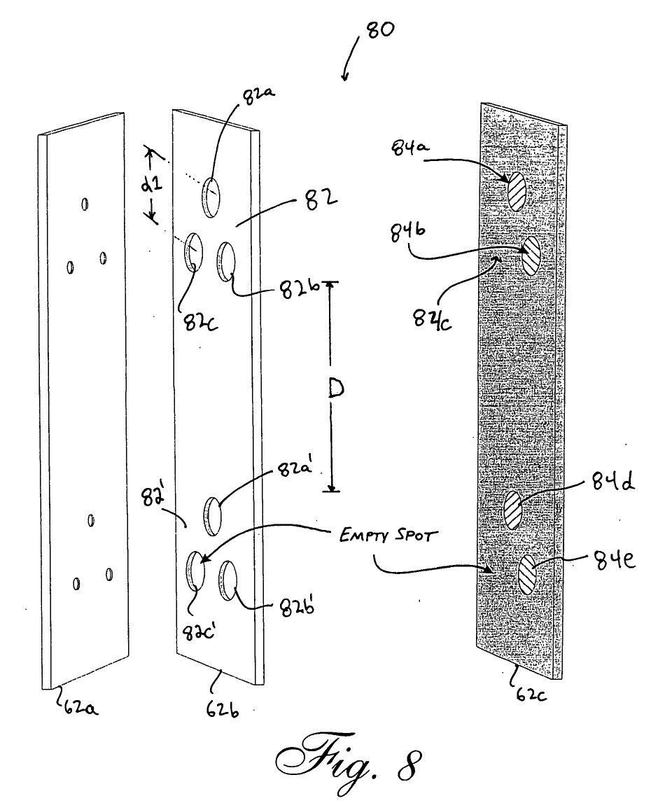

With reference to FIGS. 6a, 6b, 7a and 7b, an array 60 of a plurality of micro neutron devices can be made together on a plurality of substrates or supports 62a, 62b, 62c. Similar to FIGS. 3-5, an interior support 62b has openings 61 formed therein. Each of the exterior supports 62a, 62c has a conductive coating 64a, 64b applied thereto. In turn, on either or both of the conductive coatings 64a, 64b, although only depicted on 64b, lies a coating or layer of a neutron reactive material 62. Then, when the supports are fastened together in the direction of arrows 65, 67, e.g., sandwiched, a plurality of pockets 68 with gas 69 results. A plurality of electrical leads 63 are fashioned (e.g., evaporated, deposited, etc.) on one or more of the supports 62 to ultimately supply/obtain signals from the detectors. In turn, conductors 71, connected to external electronics, for example, (not shown) contact the leads 63. Optionally, one or more protective sleeves 75, 77 are provided. In one embodiment, sleeve 75 is a hollow support rod providing mechanical support for the conductors 71. In another embodiment, sleeve 77 surrounds sleeve 75 to provide protection to the array before it is inserted into a nuclear reactor environment. Either or both of the sleeves preferably serve to shield the array from any electromagnetic interference that may occur during operation of the reactor, thereby reducing electronic noise contributions to measurements of the detectors. Also, and with the previously described detectors, preferred pocket 68 volumes range from a few cubic micrometers to less than about 1200 mm³. Gas is introduced via construction of the array in a gas environment and various thin film and/or VLSI technologies contribute to providing the openings 61, the neutron reactive materials 62 and/or the conductive materials 64a, 64b on or in the various supports 62. Use of each individual detector occurs as previously described. Preferred spacing S between adjacent pockets preferably exists on the order of about 10 cm. Alternatively, one or more of the neutron reactive materials for the many pockets are different from other neutron reactive coatings. Still alternatively, to eliminate the requirement of a conductive material disposed on the exterior supports, it is contemplated that the exterior supports could be made of conductive materials while the interior support is exclusively an insulator. In this manner, the neutron reactive materials can be directly applied to the external supports and various manufacturing steps eliminated. It is likely though, additional insulation would be required to prevent shorting upon application of an electrical bias to the pocket.

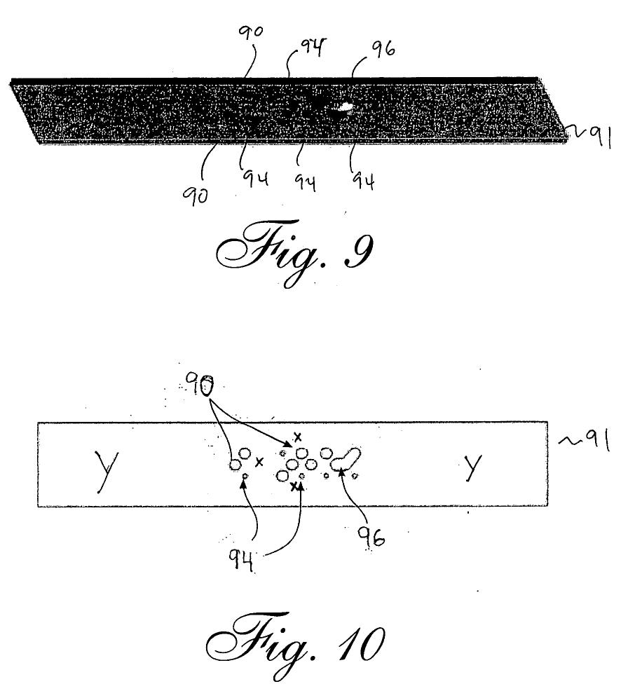

In FIG. 8, a specialized array 80 of a plurality of detectors includes the instance of one or more of a triad 82 of pockets defined by openings 82a, 82b, and 82c in an interior support 62b. In turn, a separate neutron reactive material is applied to one or both of the exterior supports 62a, 62c, although only shown on exterior support 62c, for two of the three pockets of each triad 82. For example, on exterior support 62c, a first neutron reactive material 84a is applied that corresponds to the pocket eventually formed by opening 82a upon sandwiching/fastening the three supports 62a, 62b, and 62c together. A second neutron reactive material 84b, different from the first, is applied that corresponds to the pocket eventually formed by opening 82b upon fastening together the three supports 62a, 62b and 62c. In a preferred embodiment, the first neutron reactive material is ²³²Th while the second is 93%, ²³⁵U. At a position 84c that corresponds to the pocket eventually formed by opening 82c upon fastening the three supports, there is no neutron reactive coating. In this manner each pocket of a triad 82 of the invention can provide readings different from one another to create a multi-function detector. As presently contemplated, the pockets arranged thusly enable the simultaneous detection of fast and thermal neutrons, according to those pockets with neutron reactive materials, while the no neutron reactive material pocket embodies an “empty spot” enabling background subtraction and/or baseline readings. Further, the neutron reactive materials 84d and 84e, for the second triad 82′ of pockets formed via openings 82a′, 82b′ and 82c′ upon fastening the three supports, respectively correspond to the neutron reactive materials 84a and 84b, thereby adding redundancy, or are completely separate or different neutron reactive materials thereby adding detection robustness. Naturally, gas (not shown) fills each of the pockets and contacts the neutron reactive materials, and conductive materials (not shown) underlie the neutron reactive materials for creating electrical biases across the pocket and neutron reactive materials, during use. Also not shown, but skilled artisans will appreciate they exist, are various electrical leads similar to the previous embodiments.

In still another embodiment, the empty spot shown does not need to necessarily occur in the same position (e.g., corresponding to opening 82c or 82c′) for each triad and one or both of the positions of the neutron reactive materials can be interchanged. For example, the empty spot 84c could be positioned where neutron reactive material 84a is located. In turn, neutron reactive material 84a could be located at the position where neutron reactive material 84b is located. Then, neutron reactive material 84b would be located at the position of the empty spot at 84c. Of course, other positioning is contemplated and embraced by the invention. Still further, the triads 82 shown are arranged essentially in the shape of an equilateral triangle. Other embodiments, however, contemplate other triangular relationships. In all embodiments, however, vertical separation distances D, from one triad to another, are preferably on the order of about 10 cm. On the other hand, an internal separation distance, such as indicated by distance d1, of one opening in a triad to another in the same triad preferably exists on the order of about 1 mm.

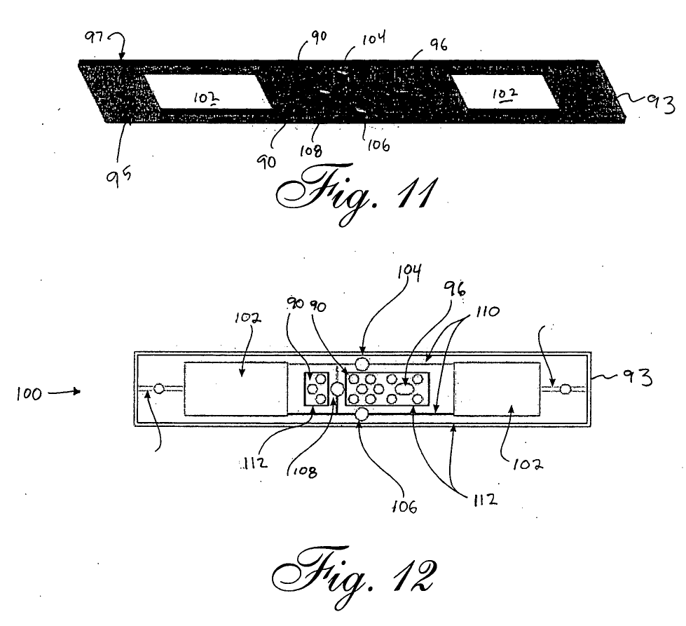

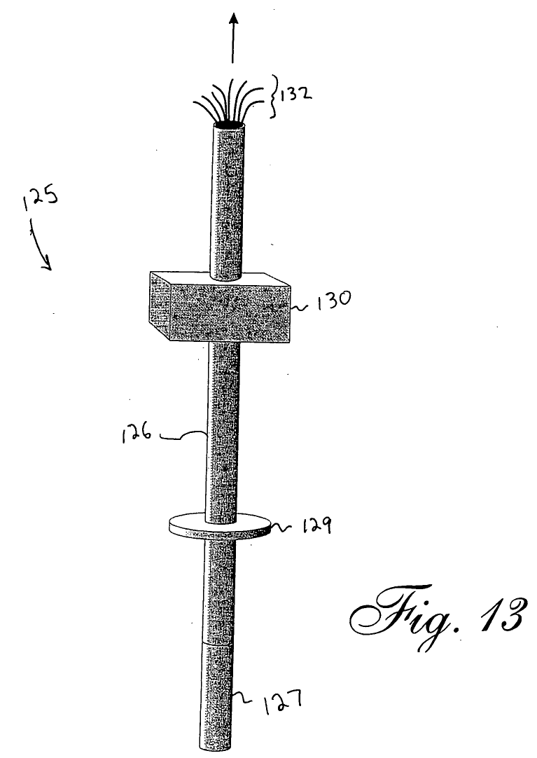

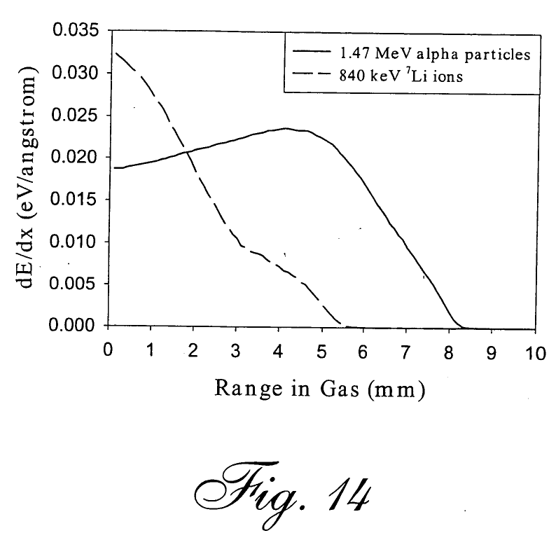

Appreciating that over time, especially after long exposures of the neutron reactive materials to radiation, the gas in the pockets of the micro neutron detectors may become less effective. Thus, FIGS. 9-12 further contemplate a detector design 100 including gas storage chambers 102 that assist to replenish the gas in pockets. Similar to prior designs, a plurality of substrates or supports 91 and 93 are designed to be fastened/sandwiched together. Namely, two supports 91 fasten on either sides 95, 97 of support 93. In turn, because of the patterning of various holes or openings, one or more pockets become defined at openings 104, 106 and 108 in the support 93. At corresponding positions labeled X on support 91, neutron reactive materials and conductive materials are coated, such as previously described. Then, when the two supports 91 and support 93 are fastened together, the pockets include corresponding neutron reactive materials on one or both sides of the pockets as well as a conductive material for use in creating an electrical bias across the pocket and neutron reactive material. Further, because the positions labeled Y on the supports 91 have no openings, upon fastening the supports together, gas storage chambers result at 102. Then, during use as gas in the pockets depletes, the gas in gas storage chambers 102 replenishes them. In this regard, gas diffusion channels 110 lead from the gas storage chambers to the pockets. Gas fill channels 114, as their name implies, also enable the filling of gas into the gas storage chamber during manufacture.

Also, because the design shown further contemplates a triad of pockets in a detector array for simultaneously detecting fast and thermal neutrons as well as providing a background or baseline reading, for example, two of the pockets preferably have different neutron reactive materials coated at any of the two positions labeled X while the third remaining position label X has no neutron reactive material. In this manner, the functionality of the design of FIG. 8 is further achieved, if desired.

To further facilitate construction of the detector, the supports have additional holes and/or channels. Namely, support 93 contemplates a variety of epoxy channels 112 that become filled with epoxy or other adhesives to assist in fastening the supports together. All supports 91 and 93 also include a variety of wire feed through holes 90 (only a few are labeled in each figure) to facilitate the interconnection of electrical leads into contact with the conductive material. A thermocouple hole 96 is provided to facilitate connections of the detector design 100 to an external environmental monitor, such as a thermocouple (not shown). Support 91, on the other hand, also has a variety of wire solder points 94 formed namely as indentations in a surface of the support.

As skilled artisans will appreciate, the supports 91, 93 can be mass-produced using common thin film and very large scale integration (VLSI) processing techniques. For instance, the patterning of holes, indentions or other can be etched entirely through supports embodied as common silicon wafers or alumina, for example. Naturally, the design and placement of these holes have an effect on the efficiency and efficacy of the process itself; and, many possibilities exist for the design of supports.

### EXAMPLE

Prototype micro neutron detectors were manufactured from machined aluminum oxide (alumina) pieces, and each detector was embodied as a plurality of three fastened supports, such as representatively shown in FIGS. 3-5. The interior support included an opening that, when fastened to the exterior supports, defined a generally cylindrical gas pocket having a 2-mm diameter and 1-mm thickness. To make the detector, compositions of Ti/Au were evaporated on each of the exterior supports to form an alumina cathode and anode. In turn, the support having the cathode was aligned and fastened to the interior support with an epoxy. A dilute solution of Uranyl-Nitrate (neutron reactive material) was then applied over the Ti/Au forming the cathode and baked with an infrared lamp for 5 minutes. Afterwards, the fastened interior support and the exterior support forming the cathode, including the baked uranyl-nitrate, were inserted into a glove box, of sorts, which was backfilled with P-10 gas. After waiting a sufficient amount of time for the gas to displace any residual air in the glove box, the other exterior support, forming the anode, was fastened with epoxy, thereby trapping the P-10 gas inside the pocket. Thereafter, the entirety of the detector was cured for 24 hours at 200° F. in a baking oven. Later, multiple other detectors were made according to this recipe.

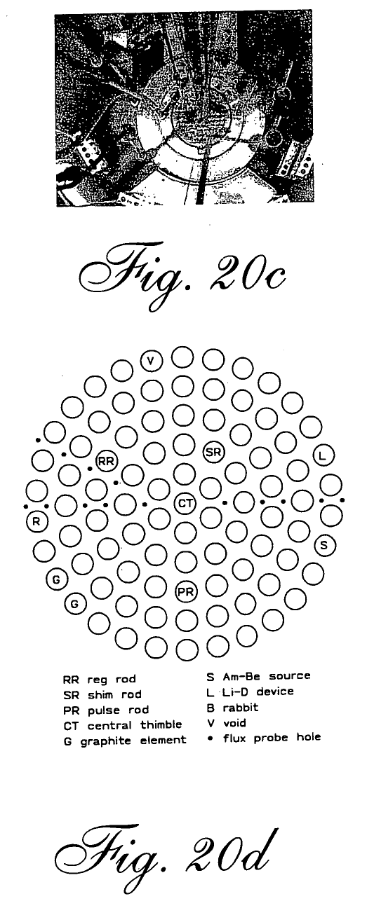

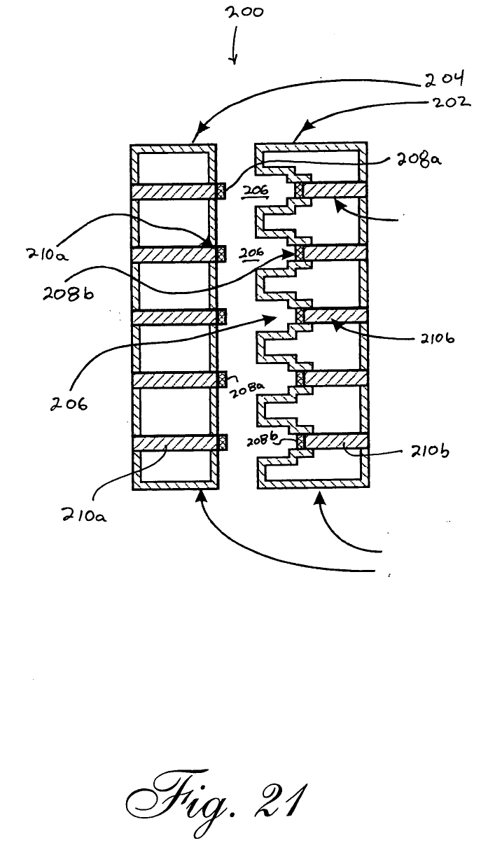

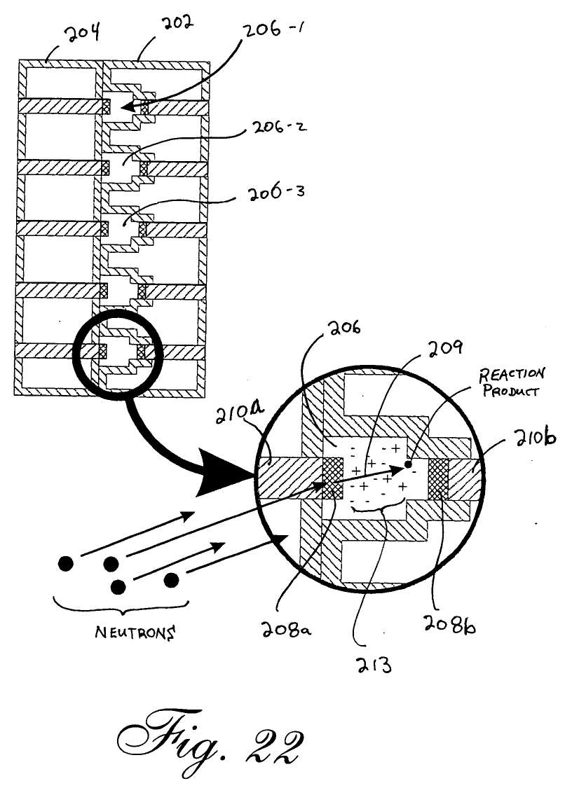

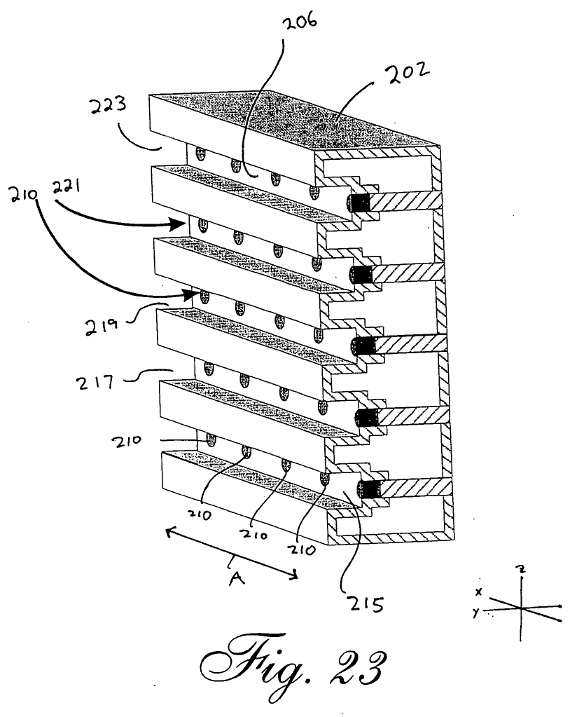

For initial testing, the prototype micro neutron detectors were introduced into a neutron environment embodied at a thermal neutron beam port 190 (FIG. 20b) tangential to the Kansas State University (KSU) TRIGA Mark II reactor core, seen in FIGS. 20b, 20c and 2d, to observe their spectral characteristics and gamma ray insensitivity. Upon a bias of +200 volts across the pocket and neutron reactive material, the detectors were tested at full reactor power, which is known to provide (at the tangential beam port) a thermal neutron flux of 1.6×10⁶ n-cm⁻²-s⁻¹. Of this, the gamma ray component is approximately 100 R per hour and spectra for the testing were accumulated with and without a Cd shutter, thereby allowing for the observation of the gamma ray contributions to the signal.

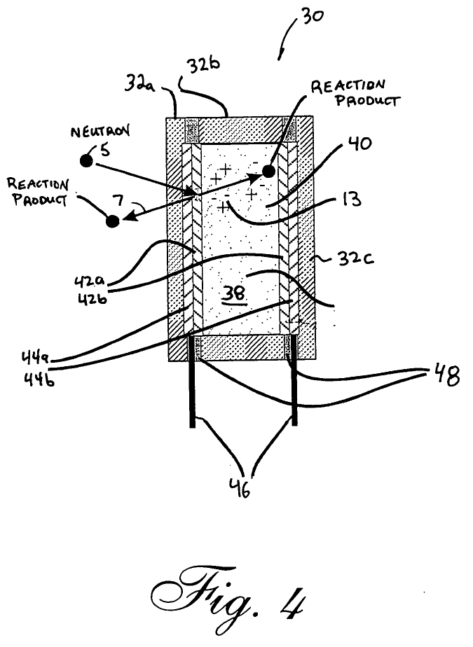

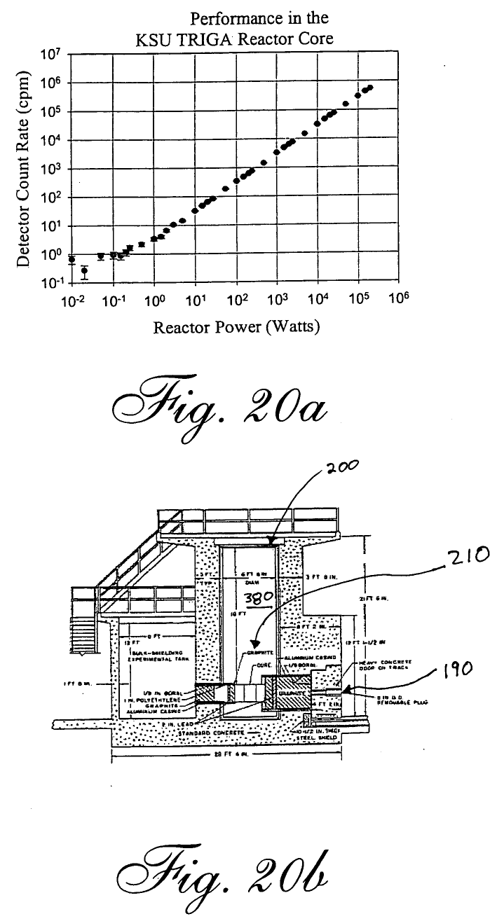

Appreciating that a neutron's angle of entry into a detector will change the magnitude of the pulse (signal) returned from the detector, a Monte Carlo code was written beforehand to model the expected pulse height distribution from a given micro neutron detector. As seen in FIG. 19b, the model depicted the expected spectral features (in terms of Number of Paths versus Path Length) for micro neutron detectors having a cylindrical pocket with both a 3-mm diameter (R=1.5 mm) and a thickness of 1-mm wide (H=1 mm); and a 4-mm diameter (R=2 mm) and a thickness of 2-mm wide (H=2 mm). What skilled artisans should appreciate is the salient energy peak predicted near mid-spectrum. For example, at path lengths of 1 and 2 mms, dramatic increases in the number of paths are expected for each of the detectors. With more specificity, the peaks indicate the average energy deposition in the detectors occurring with reaction product trajectories approximately perpendicular to the general length of the conductive and neutron reactive material (e.g., FIGS. 2 and 4), whereas the continua are from other possible angular trajectories (e.g., reference arrows 7 and 9 of FIGS. 2 and 4).

As was hoped for, FIG. 19a shows an actual fission product spectrum obtained from reading output signals of an actually tested micro neutron detector and such compares favorably to the predicted response modeled in FIG. 19b. Namely, both graphs show little or no detection at low spectrum (e.g., low Channel Number or Path Length) a sharp increase to a peak, which thereafter quickly tapers to little or no detection (e.g., at relatively high Channel Number or Path Length). Thus, the initial viability and usefulness of the micro neutron detectors were fairly proven. Also, further tests with cadmium shielding pieces between the neutron source and the micro neutron detectors showed almost no pulses from the gamma rays, demonstrating the detectors also have an excellent n/y detection ratio.

Afterwards, testing of the micro neutron detectors moved from the tangential beam port 190 to within the reactor core at 210 (FIG. 20b), for example. Within a 20 ft long aluminum sampling tube or sleeve, the micro neutron detectors were placed within the core of the KSU TRIGA Mark II nuclear reactor at positions labeled central thimble (CT) or flux probe hole (•) (FIG. 20d), for example. Connecting wires extending from the reactor core, up through the aluminum tube and at out of the top 200 (FIG. 20b) of the reactor pool, were used to connect the detectors to a commercial Ortec 142A preamplifier, thereby ensuring that the signal reading electronics (not shown) were not in a harmful radiation field. Then, detector measurements of 15-minute durations were taken with the reactor power incrementally changed in power from 1 mW up to 200 kW, hence changing the thermal flux at the detector location from 10³-10¹² n-cm⁻²-s⁻¹. Further, the detector was operated in pulse mode for the entire experiment.

Representatively, FIG. 13 shows a contemplative design of a relatively lengthy detector assembly 125 for use in this regard. Specifically, the assembly 125 includes a sleeve 126 having a terminally disposed detector cavity 127 for positioning one or more of the described micro neutron detectors deep within a relatively tall nuclear reactor. At 129, an index stop exists to prevent the assembly from traveling too deep within the reactor and/or maintain the detectors at a predetermined height. Naturally, the stop is contemplated as adjustable. At 130, the preamplifier (of the type mentioned, for instance) exists to boost signals coming from the detectors. The preamplifier also exists at a sufficiently safe distance from a core in which it is used. At 132, pluralities of electrical leads exist to ultimately connect the detectors to external electronics (not shown) for actually reading the detector signals. Ultimately, noise contributions from coupling capacitance can be reduced while minimizing radiation damage to the electronics. The entire assembly is leak proof and waterproof.

Preferred structural exteriors include aluminum.

Returning to the Example, FIG. 20a plots the observed results of the micro neutron detector(s) as Count Rate versus Reactor Power. As stated, the KSU TRIGA Reactor was operated from low power up to 200 kW, changing in fifteen-minute intervals. Unexpectedly and advantageously, the linearity of the graph (especially between reactor powers of 1 Watt to greater than 10⁵ Watts) shows that the neutron reactive material of the detectors does not degrade at higher reactor powers. Heretofore, no other detectors have achieved responses of the type indicated. Further, it is expected that if a nuclear reactor could be tested having power greater than 10⁵ Watts, the linearity of the detector response would continue. Unfortunately, for reactor powers below 1 Watt, the KSU TRIGA reactor cannot be regulated accurately enough and the graph linearity breaks down. However, it is expected that if it could be better controlled, the graph linearity would also continue for low powers. Advantageously, the tested micro neutron detectors emitted readings nearly instantaneously. Conventional gas-filled detectors, on the other hand, are of larger volume than the described invention, and the time it takes to form the signal from the device can take several hundred microseconds to several milliseconds. Under high count rate conditions, conventional detectors also do not have enough time to distinguish between separate neuron interaction events, hence the signal pulses collide, or pile-up, which causes the readout electronics to miss events, wherein the time duration of these missed events is referred to as dead-time. However, the described invention is much smaller, being a micro neutron detector, and does not suffer the dead time problem as do their conventional counterparts. This substantially reduced dead-time amounts to a further significant advancement over the prior art, in which present day, conventional detectors are unable to measure a count rate above 10⁴ counts per second (cps) without substantial dead time or rollover. Moreover, the lack of dead time in the instant invention eliminates both the need to calibrate the timing of the detector signals and the need to use a correlation chart, as is often presently done.

As a result, the EXAMPLE clearly shows capability of measuring thermal neutron fluxes in micro neutron detectors ranging from 10⁻³-10¹² n-cm⁻²-s⁻¹ with no sign of dead time losses. To date, further testing has revealed micro neutron detectors withstanding neutron fluences exceeding 10¹⁹ n-cm⁻² without any noticeable degradation. The count rate observed, however, is still below the theoretical maximum; hence, the detectors are expected to operate, still in pulse mode, within the higher neutron fluxes of power and naval reactors.

As further advantage, since the charge-detecting medium of the detectors is a gas, it is improbable that gamma rays will ever interact therein; hence, the micro neutron detectors of the instant invention naturally discriminate out gamma-ray background noise. Furthermore, since the device is gas-filled, there is no detecting medium that radiation can actually destroy. This too is a clear advantage over prior art liquid or solid detectors. The detectors are also much more radiation hardened than typical semiconductor and liquid-based neutron detectors as well.

With reference to FIGS. 21-30, other embodiments of micro neutron detectors of the invention are given generically as 200. In one instance, they include an array of a plurality of detectors. In another, they embody pluralities of pockets formed as adjacent capillary channels. During use, however, they behave as the previously described embodiments. In a broad sense, the detectors include: a pocket, with gas or a fluid; a neutron reactive material forming a portion of the pocket and contacting the gas; and an electrical bias across the pocket and neutron reactive material. In this manner, when introduced in a neutron environment, neutron interactions in the neutron reactive material cause charged particles (reaction product) to eject in opposite directions. When these energetic ionizing particles enter the pocket filled with gas or fluid, they produce ionization in the form of electron-ion pairs. In turn, the applied voltage (electrical bias) causes the positive ions and the electrons to separate and drift apart, electrons (−) to the anode and positive ions (+) to the cathode. The motion of the charges then produces an induced current that is sensed and measurable (e.g., signal), thereby indicating the interaction of neutron(s) in the detector. A conductive material provides the means to get the signal from the detector.

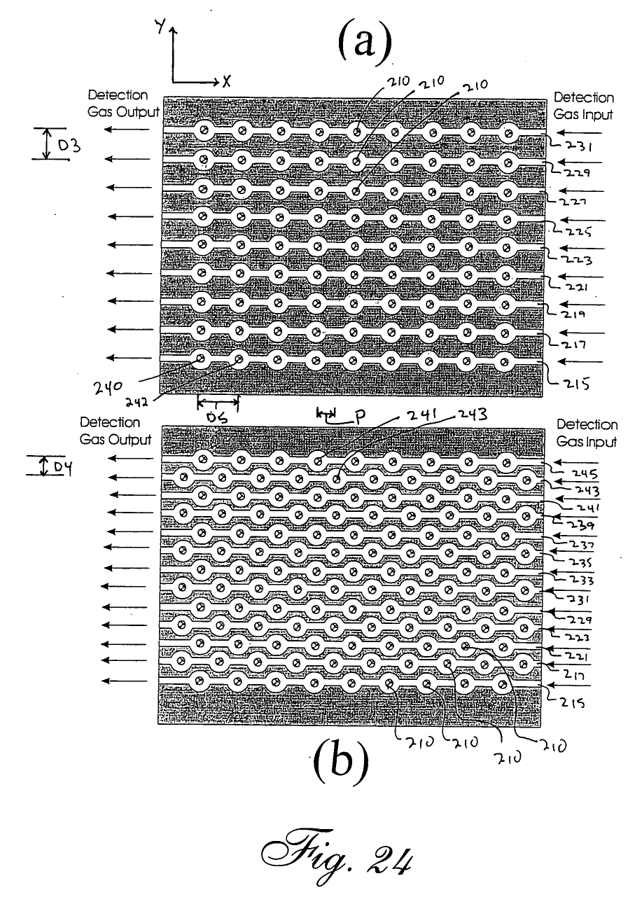

With more specificity, FIGS. 21 and 22 show a plurality of detectors 200. In general, first and second supports or substrates 202, 204 are fabricated with corresponding features or surfaces, such that upon their fastening together, pluralities of pockets 206, in the form of channels, result. In one instance, the supports or substrates embody semiconductor or silicon wafers readily and easily fabricated via thin film and VLSI techniques. In another, they embody alumina and are readily and easily fabricated with laser ablation, for example. Still other supports contemplated include the insulators previously described.

In either, a neutron reactive material 208 is a feature of the support and forms a portion of each pocket 206 on either or both sides, such as at both positions 208a and 208b or at either one of the positions 208a or 208b. Candidate neutron reactive materials have already been recited and similar or different materials can be used for each pocket 206-1, 206-2, 206-3, etc. to create similar detectors or simultaneously a fast and thermal neutron detector (including or not a pocket 206 with no neutron reactive material to obtain a baseline or background reading as previously discussed). A conductive material 210 contacts the neutron reactive material and is used to obtain the signals of the detectors and apply an electrical bias to the pocket. Naturally, if the neutron reactive material 208 only existed at either one of positions 208a or 208b, the conductive material itself would further exist in direct contact with the gas in the pocket (not shown).

In one manufacturing embodiment, the conductive material is positioned by forming a via-hole in the supports 202, 204 and then filling the hole with a conductor. Candidate conductors have, of course, already been recited. Once formed, the neutron reactive material is then patterned on top of the conductor. Skilled artisans will appreciate that fabrication of these supports will likely occur with an orientation perpendicular to that shown in FIGS. 21 and 22, such that a neutron reactive material existing on ‘top’ of the conductor relates to the well known practice of fabricating substrates on a top surface of an underlying surface. Representatively, this is seen in FIG. 30, for example in which a support, e.g., 270, 290, undergoes fabrication through steps (1), (2), (3) and (4). More on this will be described below.

During use, referring back to FIGS. 21 and 22, the detectors exist in a neutron environment, labeled “neutrons.” As neutron interactions in the neutron reactive material 208a occurs, charged particles are caused to eject in opposite directions (although only direction 209 is shown). When these energetic ionizing particles (reaction product) leave the neutron reactive material and enter the pocket 206 filled with gas or fluid, they produce ionization in the form of electron-ion pairs 213. In turn, and appreciating an electrical bias, in the form of a voltage across the pocket and neutron reactive material exists via the conductor material 210a, 210b, the positive ions and the electrons to separate and drift apart, electrons (−) to the anode and positive ions (+) to the cathode. The motion of the charges then produces an induced current that is sensed and measurable (e.g., signal), thereby indicating the interaction of neutron(s) in the detector 200.

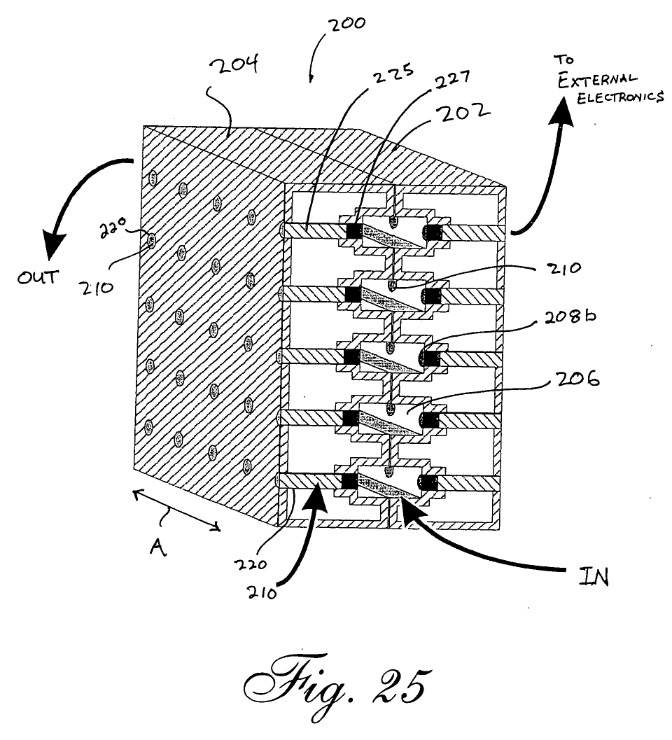

With reference to FIG. 23, and appreciating the support 202 exists in three-dimensions, vice the two dimensions shown in FIGS. 21 and 22, each pocket 206 resides longitudinally along the support in the direction of bi-directional arrow A. Representative volumes of these pockets also preferably range from a few cubic micrometers to less than 1200 mm³. In length (direction of arrow A and x-axis), they will average about 20 cm, more or less. In depth (y-axis), they will be about 1 mm. In the direction of the z-axis, each channel will be about 1 mm. Also, because the conductor material, also referred to in this view as contacts, preferably is formed in via-holes in the support, pluralities of the contacts 210 can exist in the directions of arrow A in a single pocket or channel especially labeled 215, for example. In turn, because each channel 215, 217, 219, 221, 223 has pluralities of such contacts, signal outputs can be obtained at each individual contact thereby lending the development of an X-Y-Z axis map of neutron fluxes for any given neutron environment in which a single detector array 200 is placed. Further, with the addition of multiple arrays of such detectors placed throughout a nuclear reactor, for example, a comprehensive X-Y-Z map can be made for the entirety of the reactor. Although X-Y-Z mapping can also occur by positioning pluralities of the individual detectors previously mentioned (e.g., FIGS. 1-5) comprehensively throughout a reactor, this embodiment would naturally be able to accomplish it with fewer overall detector housings.

With reference to FIG. 25, a three-dimensional view of an entirely assembled array of detectors 200 is seen, especially the feature of a conductor material 210 existing in an entirety of a via-hole 220 etched, for example, in a support 204. Further, the conductor material of this or other embodiments may separately and distinctly include a contact. Representative materials for the contact especially include, but are not required to be, any of Ti, Au, Pt or Pd.

Further, this embodiment especially contemplates that gas in the pockets 206 may be flowed along the length of any given channel in the direction(s) of arrow A, for example. As presently depicted, gas will flow in the channel in the direction of arrow IN and will flow out in the direction of arrow OUT. In a preferred embodiment, gas flow rates on the order of standard cubic feet per hour (scfh) are contemplated. Gas compositions are of those already described. In alternate designs, each individual channel could have its gas flow IN and OUT reversed from that shown. Still alternatively, gas can be substantially permanently sealed in the pockets, not flowed, as with some of the previous embodiments and can be done in the manners described in a gas environment, for example.

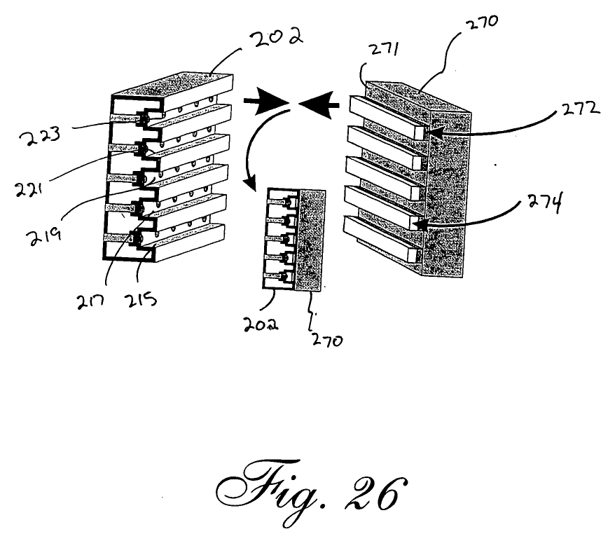

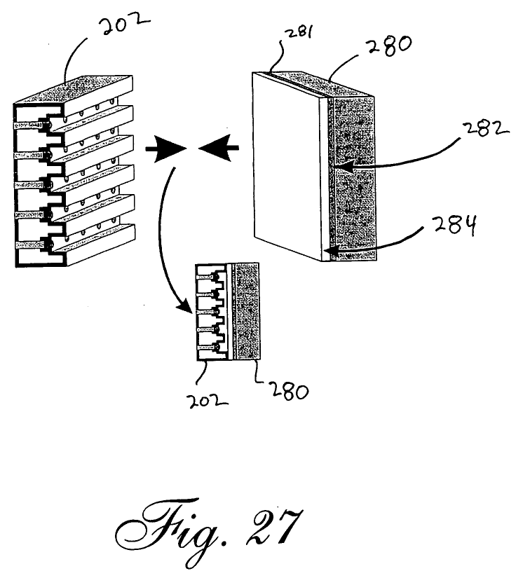

With reference to FIGS. 24a and 24b, a planar view of a cross-section of the pockets or channels (oddly numbered from 215-245 in the views) and their gas flow directions is seen. Individual conductor materials 210 in adjacent channels, however, align with one another in the X-direction in FIG. 24a, but not in FIG. 24b. In one instance, adjacent channels are separated by a distance D3 of about 3 mm. In another, adjacent channels are separated by a distance D4 of about 2 mm. In the X-direction, conductor materials 240, 242 are separated by a distance D5 of about 3 mm. While a stagger or pitch P between conductor materials 241, 243 exists on the order of about 2 mm. Of course, other arrangements of conductor materials are contemplated and embraced herein.

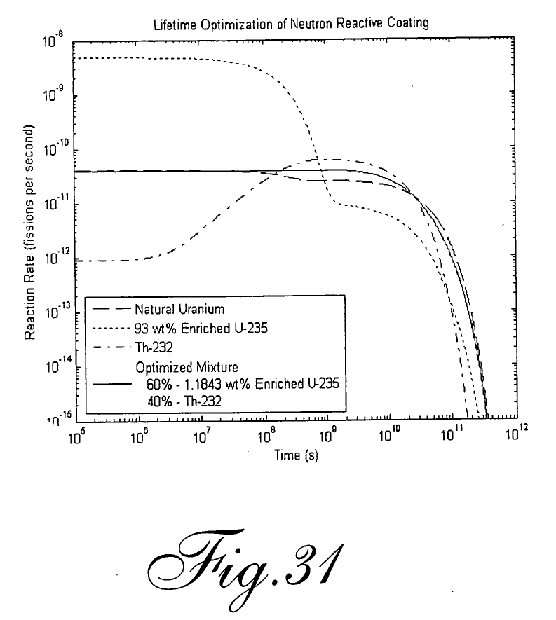

With reference to FIG. 29, completely assembled supports 202, 204 could further be mounted, mechanically and electronically, onto substrates, such as a printed circuit board (PCB) 250, to facilitate readout of the signals of any of the micro neutron detectors. In one instance, dedicated readout connector ribbons 252, 254 could attach to the PCB 250 and relate respectively to the signals from the conductor materials arranged in the X and Y directions of FIG. 24, for example. Further, externally supplied gas could be flowed through pockets 206 via connections 260, 262. As shown, gas is supplied into the pockets from two directions (e.g., 260 and 262). Thus, gas out could exit from side 264. Alternatively, either of connections 260 or 262 could be configured such that one supplies gas in and one receives gas out. Skilled artisans can, of course, contemplate other examples.

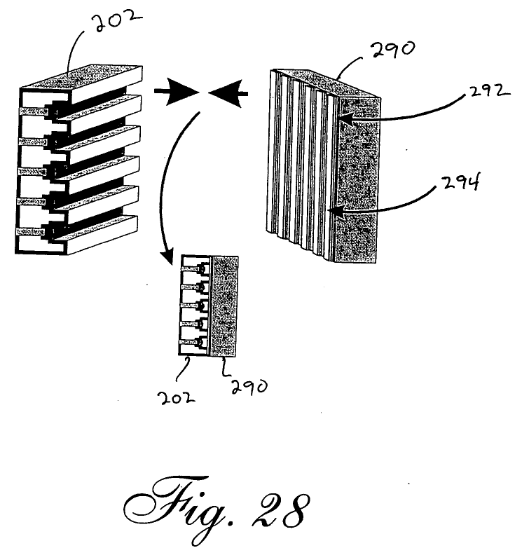

With reference to FIGS. 26-28, alternate fabrication of a plurality of micro neutron detectors formed with supports having channels as pockets is contemplated. For example, FIG. 26 shows a support 202 as already described. However, support 270 is essentially flat on a surface 271 and strips of materials 272, 274 are fabricated, through techniques previously mentioned, to represent rows of contacts 272 and rows of neutron reactive materials. In this manner, only one substrate, e.g., 202, needs to have a channel 215, 217, 219, 221, 223 fashioned therein. In turn, this facilitates ease of manufacturing.

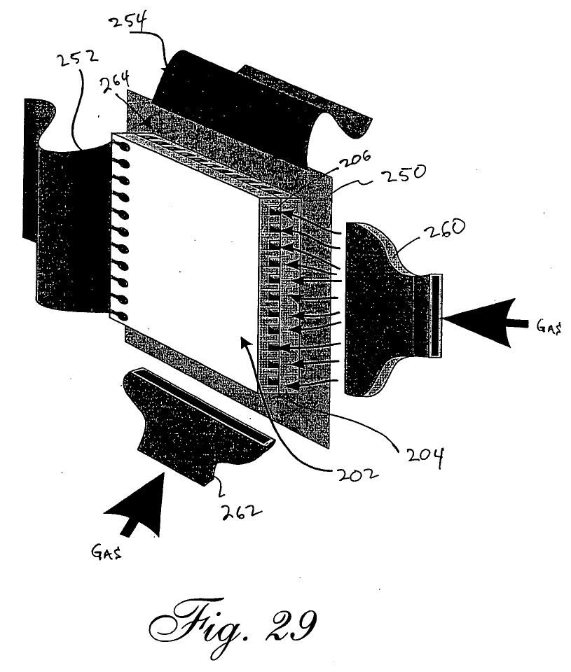

In FIG. 27, support 202 is fastened with support 280 to form a plurality of micro neutron detectors. However, support 280, instead of having strips of materials for contacts and neutron reactive materials, has a substantial entirety of its surface 281 coated with, first, a conductor material for the contacts and, second, with a neutron reactive material. In this fashion, no patterning, etching, etc., need occur with the support 280 and further eases manufacturing constraints.

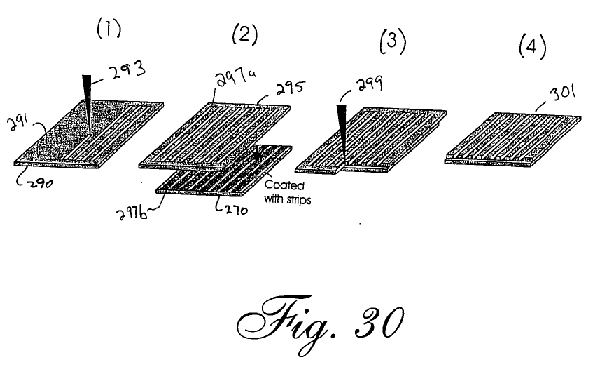

In FIG. 28, support 202 is fastened with support 290. In this instance, support 290 has strips of materials to form contacts 292 and neutron reactive materials 294, however, these strips are oriented perpendicularly to those of FIG. 26. In this fashion, readout of the detected neutrons, for example, reveals precise locations by appreciating anodes, for example, exist with support 202 and cathodes with support 290. As a result, the location of neutron interaction events can be determined as a function of the nearest intersection point of channels from which the signals are extracted.

With reference to FIG. 30, processing steps on a support 270, 290 to receive strips of materials is seen diagrammatically as (1), (2), (3) and (4). Shown (1) is a possible method by which to fabricate one side 291 of the channel detector, in which a substrate 290 is ablated with a laser 293 to form grooves entirely through the material. Afterwards, (2) the grooved substrate 295 is attached to a second substrate 270 upon which metallic strips are coated with neutron reactive material. The grooves 297a are aligned with the metallic strips 297b. The (3) excess material from the grooved substrate is cut at 299 from the configuration, leaving (4) a prepared single side of a channeled or capillary detector 301.

In either of the embodiments of FIGS. 21-30, for example, it is expected that an increase in the number of preamplifiers would be required to boost signals levels, leading to external electronics, compared to other designs. Nonetheless, these designs will offer a high spatial resolution detector that is significantly more radiation hard than semiconductor counterparts. They are also expected to be used at facilities where neutron measurements are important in the energy range usually characterized by cold to epi-thermal neutrons. High density polyethelene (HDPE) plates in front of sections of the detector (not shown) can further be used to thermalize fast neutrons and provide some energy information on the incident neutron field. Selectively chosen collimator holes (not shown) in the HDPE can assist with directional sensitivity. Any of the supports, especially if embodied as semiconductor or silicon wafer, may additionally have an oxide layer grown over an entirety thereof to serve as insulation.

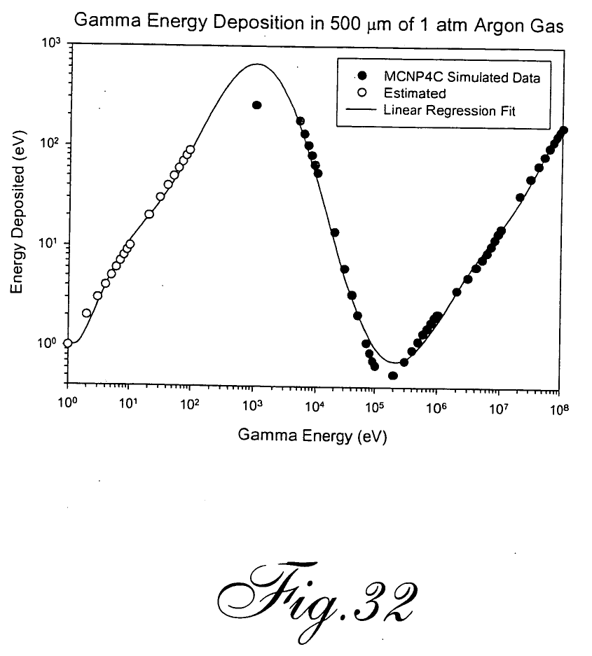

With reference to FIG. 31, skilled artisans will appreciate the response of the neutron reactive material of the inventive micro neutron detectors will change over time. In this regard, the lifetime reaction rate of various nuetron reactive materials are given. Also, great differences in reaction rates are seen between ²³⁵U and ²³²Th in early stages of their respective lives. Thus, this is one reason for selecting these two materials to play a respective role in a micron neutron detector embodied as a triad for simultaneously detecting both fast and thermal neutrons. Namely, highly enriched ²³⁵U will have a principally thermal neutron response while detectors coated with ²³²Th will have a fast neutron response. Additionally, knowledge of any given reactor's energy dependent neutron flux profile allows for a detector's lifetime optimization, including a flatter neutron response. For example, the KSU TRIGA Mark-II nuclear reactor may operate at a constant steady state power of 250 kW. As can be seen in the graph, one percent signal change in this reactor under such conditions for natural uranium would be reached in only 0.268 years, 0.038 years for 93 wt % enriched ²³⁵U, and less than 1 week for ²³²Th. However, by using a 60/40 mixture of 1.1843 wt % enriched ²³⁵U and ²³²Th, the lifetime can be extended to 57.59 years for 1% signal change. A 5% signal change, on the other hand, would occur in 87.72 years while a 25% signal change in 237 years. Thus the coatings may be tailored for each detector's use and to provide specific neutron energy information.

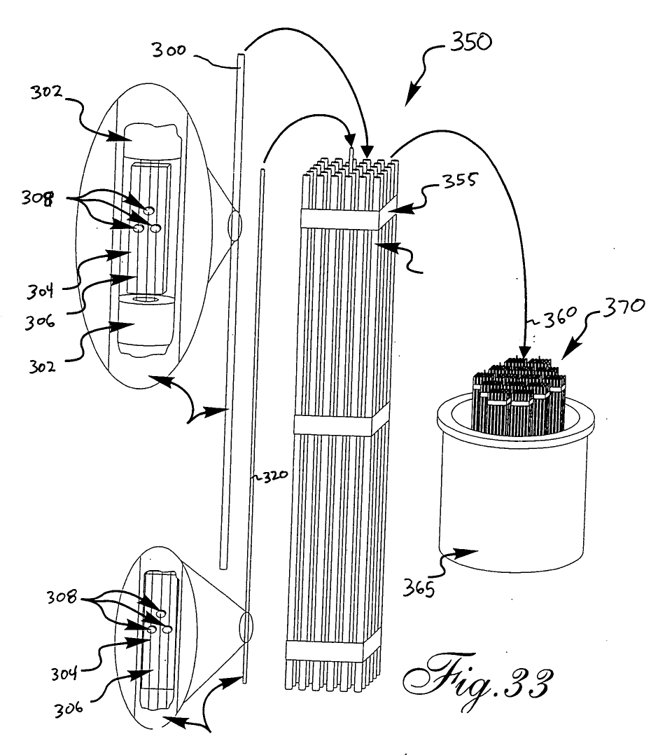

With reference to FIG. 32, the background insensitivity of a representative micro neutron detector of the invention is seen. Namely, a graphical analysis appears for gamma-ray energy deposition in 500 microns of 1 atm argon fill gas (very similar to P-10 gas) for various gamma-ray origination energies. Applying a curve fit to this data, along with the assumption that the maximum energy deposition cannot exceed the origination energy of the gamma-ray, it is obtained that the greatest energy will be departed by a 1 keV gamma-ray and will deposit only 658 eV. This is insignificant and easily discriminated out when compared to the 3 MeV signals from fission products.

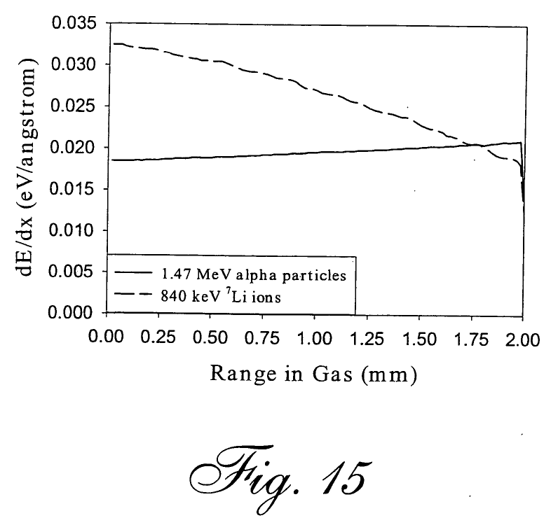

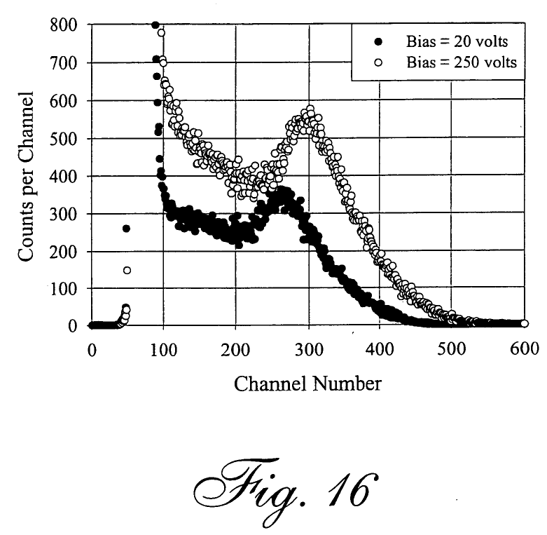

With reference to other graphs, the energy deposition and ranges of ¹⁰B reaction products in 1 atm of P-10 gas are shown in FIGS. 14 and 15. Clearly, only a fraction of energy will be deposited within a two-mm wide cavity of P-10 gas. However, from FIG. 15, the average energy deposited from the 1.47-MeV alpha particle will be 0.02 eV/angstrom, which is approximately 400 keV for a 2-mm wide cavity. The 840-keV Li ion deposits more energy, averaging approximately 500 keV for a 2-mm wide cavity. FIG. 16 shows a thermal neutron reaction product spectrum taken with a prototype ¹⁰B-coated MPFD. Designed and constructed by the inventors, the device was manufactured with a 1-micron ¹⁰B coating atop aluminum oxide walls and had a 2.5-mm diameter gas pocket that was 2 mm wide. Two spectra are shown: one with 20 volts bias and the other with 250 volts bias. When biased at 20 volts, the integrated counts yielded 1.1% neutron detection efficiency, and when biased to 250 volts yielded 2% thermal neutron detection efficiency. The total count rate increased up to a bias of 100 volts, after which the count rate stabilized. This important result demonstrates that the proposed device is viable and can be operated at modest voltages.

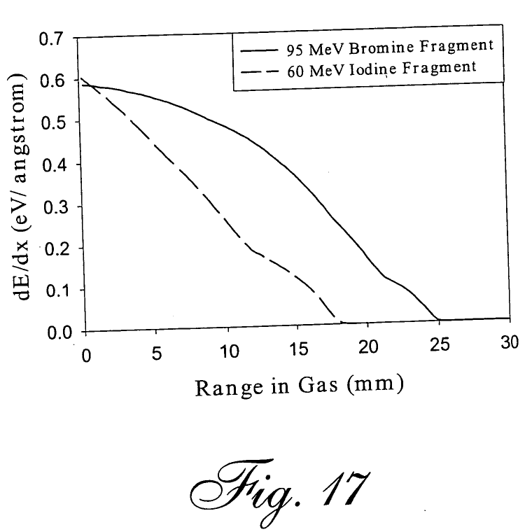

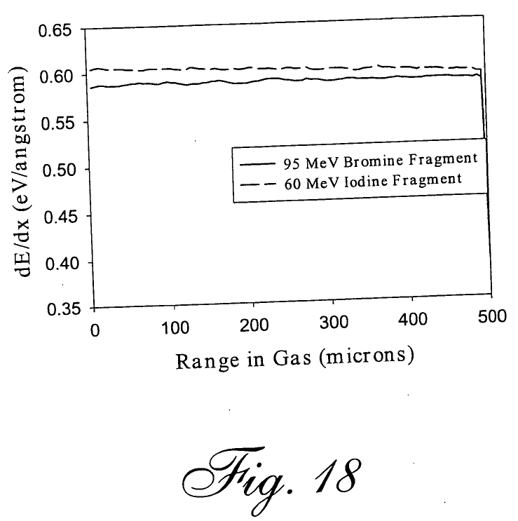

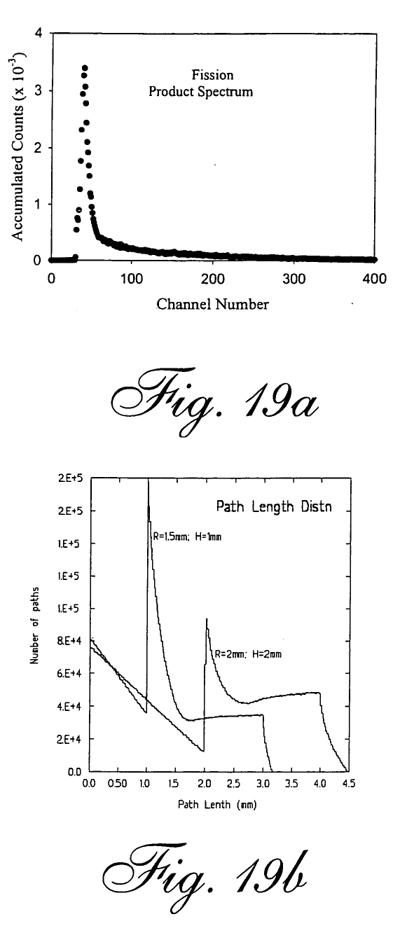

For micro neutron detectors with ²³⁵U as the reactive film, FIGS. 17 and 18 show the ranges and energy deposition within 1 atm of P-10 gas for 95 MeV bromine fission fragments and 60 MeV iodine fission fragments. It again becomes obvious that the fission fragments will only deposit a small portion of energy within the pockets, yet from FIG. 18, the deposited energies will be 2.9 MeV for the bromine fragment and 3 MeV for the iodine fragment, all within a pocket cavity only 500 microns wide (e.g. t1). Energies of such large magnitude will be easily discriminated from background gamma rays, and the thinner gas pocket requires only 25 volts operating bias.

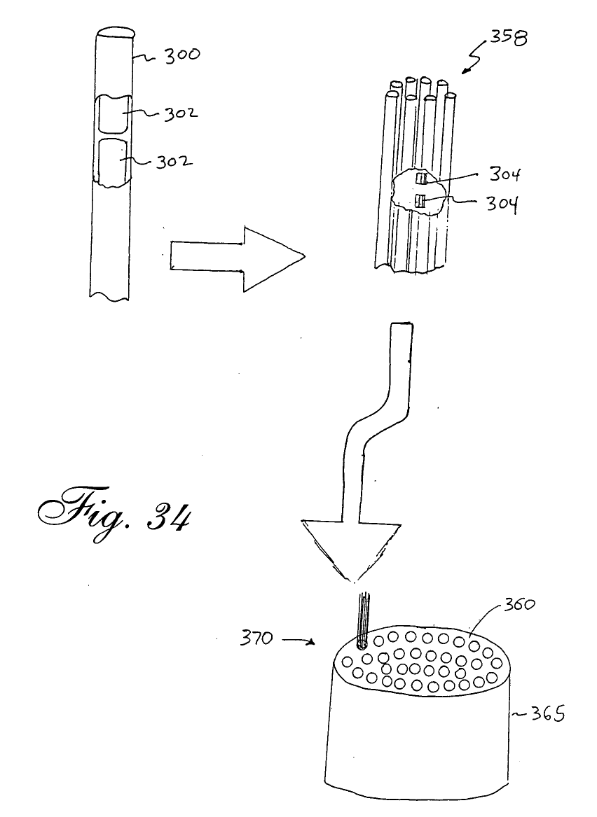

With reference to FIG. 33, any one or more micro neutron detectors of the invention can be associated with and remain with a fuel bundle for times of use in nuclear reactors and later after fuel bundle burn-up. In this manner, upon inserting the fuel into the reactor, detectors are also inserted and provide an instantaneous in-core neutron flux measurement capability. During use, this also adds to reactor fuel efficiency increases because real-time adjustments of fuel bundle location or locating spotty fuel burn-up, for example, can be made based on the output readings of the detectors. Appreciating average fuel bundles cost hundreds of thousands of dollars or more, the more effective burning of fuel will certainly save money too. Further, upon removal of the fuel bundle from the reactor, after use, the detectors can remain with the bundle and later provide an indication of the state of the bundles, such as before/during transportation to waste sites.

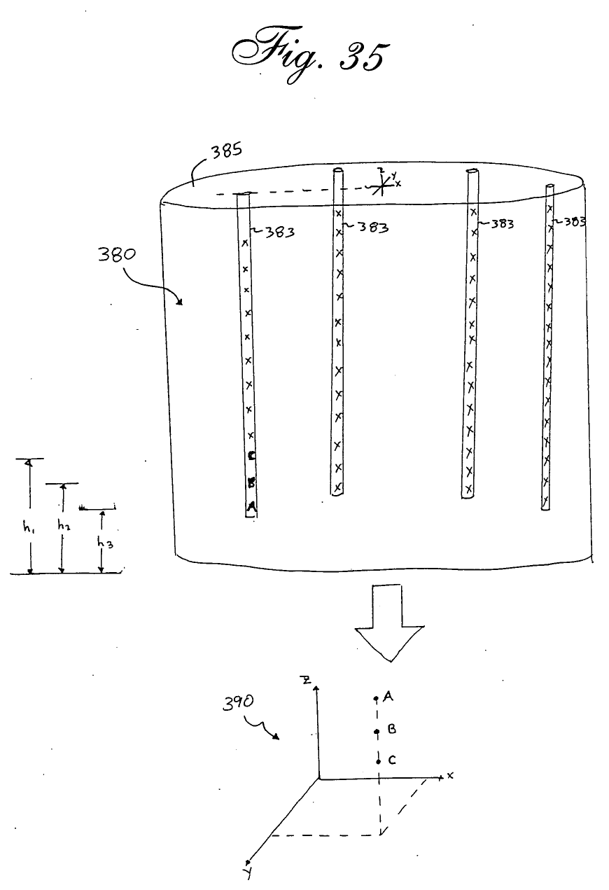

As is known, a fuel rod 300 is comprised of a plurality of fuel pellets 302. In turn, pluralities of fuel rods combine to form a fuel bundle 350. The fuel bundle is then geometrically dispersed 360 in a reactor vessel 365 to form a reactor core 370. In one embodiment, dispersed amongst the pellets is one or more micro neutron detectors 304, having pockets 308, of the type previously described. In turn, electrical leads or wires 306 extend from the detectors for obtaining detector signal readouts. In another, an instrument rod 320 includes the one or more detectors and the rod itself is co-located with a fuel bundle 350 and bound with a well-known fuel bundle support 355. Also, the instrument rod may be of the type representatively seen in any of FIGS. 6, 7 and 13 and placement of the rod may also occur at various positions, especially the flux probe hole position of FIG. 20d. FIG. 34, on the other hand, serves to illustrate the concept of FIG. 33 except for showing a representatively cylindrical fuel bundle 358 that often typifies a CANDU fuel bundle. In either, the fuel bundles 350, 358, are further disposed in a moderator 380 of the nuclear reactor, representatively seen in FIG. 20b.

Apart from the fuel bundles, skilled artisans will appreciate that insertion of the micro neutron detectors of the invention are readily placed in the moderator 380 (FIG. 20b) of a given nuclear reactor. In this regard, dispersal in three-dimensions will readily lead to mapping an entirety of neutron flux of a reactor.

For example, with or apart from the fuel bundles, FIG. 35 shows pluralities of micro neutron detectors, labeled X, inserted into a reactor moderator 380. In one embodiment, it is anticipated to place forty-five to fifty such neutron detectors in the moderator in a vertical manner, such as on one or more rods 383 (shielded or not with sleeves previously described). In turn, each detector exists at various heights in the moderator, such as representatively seen by h1, h2, h3 for each of the micro neutron detectors C, B and A, respectively. Then, upon taking the readings/measurements of the detectors, and appreciating that each rod 383 has a different X-Y position in a plane shown as 385, a three-dimensional map 390 of the neutron flux of the reactor can be obtained via correlation to each detector, such as the detectors labeled A, B and C.

The foregoing description is presented for purposes of illustration and description of the various aspects of the invention. The descriptions are not intended to be exhaustive or to limit the invention to the precise form disclosed. The embodiments described above were chosen to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A fuel bundle for a nuclear reactor, comprising:
one or more fuel pellets arranged as one or more fuel rods; and
a micro neutron detector with the one or more fuel rods.

2. The fuel bundle of claim 1, wherein the micro neutron detector has a pocket with gas and a neutron reactive material in contact with the gas.

3. The fuel bundle of claim 2, wherein the pocket has a volume of less than about 100 mm³.

4. The fuel bundle of claim 1, wherein the one or more rods form a cylinder shape and the micro neutron detector is dispersed within an interior of the cylinder.

5. A nuclear reactor, comprising:
one or more fuel bundles dispersed in a moderator; and
a plurality of micro neutron detector with the one or more fuel bundles.

6. The nuclear reactor of claim 5, wherein one or more of the micro neutron detectors have a pocket with gas and a neutron reactive material in contact with the gas.

7. The nuclear reactor of claim 5, wherein the plurality of micro neutron detectors are dispersed at various heights in the moderator.

8. A nuclear reactor having a moderator, comprising:
a plurality of micro neutron detectors in the moderator.

9. The nuclear reactor of claim 8, wherein one or more of the micro neutron detectors have a pocket with gas and a neutron reactive material in contact with the gas.

10. The nuclear reactor of claim 9, wherein the pocket has a volume of less than about 100 mm³.

11. The nuclear reactor of claim 8, wherein the plurality of micro neutron detectors are dispersed at various heights in the moderator.
